(19) United States
(12) Patent Application Publication
(10) Pub. No.: US 2016/0216381 A1
(43) Pub. Date: Jul. 28, 2016

(54) IMAGING DEVICE, ELECTRONIC APPARATUS AND IMAGING METHOD

(71) Applicant: SONY CORPORATION, Minato-ku, Tokyo (JP)

(72) Inventors: Toshiyuki NISHIHARA, Kanagawa (JP); Hirofumi SUMI, Kanagawa (JP)

(73) Assignee: SONY CORPORATION, MINATO-KU, TOKYO (JP)

(21) Appl. No.: 14/649,643

(22) PCT Filed: Nov. 25, 2013
(86) PCT No.: PCT/JP2013/006910

§ 371 Date: Jun. 4, 2015

(30) Foreign Application Priority Data
Dec. 20, 2012 (JP) 2012-277559
Oct. 18, 2013 (JP) 2013-217060

(51) Int. Cl. G01T 1/164; G01T 1/20

(52) U.S. Cl. CPC G01T 1/1644; G01T 1/2002; G01T 1/2018

(57) ABSTRACT

An imaging device and an imaging method are described herein. By way of example, the imaging devices includes a scintillator plate configured to convert incident radiation into scintillation light and an imaging element configured to convert the scintillation light to an electric signal. The scintillator plate includes a first scintillator partitioned from a second scintillator by a divider in a direction perpendicular to a propagation direction of the incident radiation. The divider prevents first scintillation light generated in the first scintillator from diffusing into the second scintillator and second scintillation light generated in the first scintillator from diffusing into the first scintillator.

### TECHNICAL FIELD

The present disclosure relates to an imaging device. In detail, the present disclosure relates to an imaging device that detects radiation, and an electronic apparatus that includes the same.

### BACKGROUND ART

In recent years, an introduction of a medical diagnostic apparatus using photon counting of radiation has progressed. A single photon emission computed tomography (SPECT: gamma camera) and a positron emission tomography (PET) are examples of such medical apparatuses. In the photon counting of the radiation, in addition to execution of counting the number of photons of the radiation incident on a detector, the energy intensity of individual photon of the radiation is detected, and then filtering of the count corresponding to the energy intensity is executed. Currently, the radiation detector generally used for this purpose is configured to have a combination of a scintillator and a photomultiplier tube. When the photon of the radiation is incident on the scintillator, a weak pulse of scintillator light is generated. This pulse is detected in the photomultiplier tube, the output intensity thereof is measured by an AD (analog to digital) converter via an amplifier installed in the latter stage. For example, the energy of the photon of the radiation is derived from the height of the pulse.

In the photon counting of the radiation accompanied by such energy discrimination, a scattered radiation in which the radiation loses the position information and becomes a noise can be filtered. Therefore, it is possible to obtain a high contrast in image capturing. For this reason, the photo counting like this, for example, is expected to be useful means for obtaining both of the low exposure and the high resolution also in the image capturing by an X-ray mammography or a computed tomography (CT). Since the image capturing like this requires a higher space resolution, direct detection by cadmium telluride or the like is studied in general.

On the other hand, as a new detector for counting the radiation, in recent years, a detector using an APD array in which avalanche photo diodes (APD) are arrayed and the scintillator is proposed (for example, refer to PTLs 1 and 2). The APD array is also called a silicon photomultiplier (PMT). In the detector like this, with respect to the scintillator having 1 mm angle, a detection unit is configured to array a number of semiconductor APDs that operate in a Geiger mode, and the energy of the incident radiation can be derived by summing the number of discharged APDs.

### CITATION LIST

### Patent Literature

PTL 1: Japanese Unexamined Patent Application Publication No. 2009-25308

PTL 2: Japanese Unexamined Patent Application Publication (Translation of PCT Application) No. 2011-515676

### SUMMARY

### Technical Problem

However, in the technology described above, it is difficult to improve the accuracy of the photon counting of the radiation. In the detector described above, in the Geiger mode, since the APD needs an extremely high electric field higher than a breakdown voltage of the APD, such electric field causes re-distribution of charges to occur throughout, a wide range of a semiconductor substrate, thus, it is difficult to confine such influence to a small area. In addition, it is necessary to provide a protection circuit or the like such that elements such as a transistor are not destroyed due to the high voltage. For this reason, a cell size of approximately 40 micrometer is the limit of miniaturization. Therefore, it is also difficult to miniaturize the size of the detection unit in which the elements are arrayed, and the length of the unit in PTL 1 is also approximately 1 mm angle. On the other hand, for example, in the transmission imaging by the X-ray, the number of radiations incident on 1 mm angle of light receiving unit is tens of thousands or several millions per second in mammography imaging and increases in a digit order in CT imaging, while it is less than one hundred per second in gamma camera imaging. In this case, the frequency of the radiation of the scintillator becomes extremely high, thus, the scintillation light pulse is generated at a high frequency, and the light diffuses in the scintillator. Here, for distinguishing the individual emitted light by the incident radiation from each other, an extremely high time resolution is needed because there is no other way but monitoring the temporal change of light amount.

Furthermore, with respect to such incident radiation at the high frequency, next light emission occurs even before the attenuation of the scintillator light emission, which causes a serious problem of a phenomenon called pile-up. Therefore, a high specification is also required in attenuation characteristics of the scintillator and analysis and understanding of the pulse shape are required.

In addition, the APD which holds a strong electric field therein in dark state has a high dark current (dark count), and the APD is to necessarily be cooled before using. As in PTL 2, when an active quenching circuit, an output circuit, or the like is integrated in the cell, that also requires high breakdown voltage characteristics. Therefore, an occupied area for the separation increases, and then an aperture ratio and a quantum efficiency deteriorate. Like this, in the detector which performs photon counting using the APD, it is difficult to improve the accuracy.

It is desirable to improve the accuracy in photon counting of the radiation. Moreover, the effects described herein are not necessarily intended to be limited, and those may be the effects of any description in the present disclosure.

### Solution to Problem

An imaging device and an imaging method are described herein. By way of example, the imaging devices includes a scintillator plate configured to convert incident radiation into scintillation light and an imaging element configured to convert the scintillation light to an electric signal. The scintillator plate includes a first scintillator partitioned from a second scintillator by a divider in a direction perpendicular to a propagation direction of the incident radiation. The divider prevents first scintillation light generated in the first scintillator from diffusing into the second scintillator and second scintillation light generated in the first scintillator from diffusing into the first scintillator.

Further by way of example, the imaging method includes generating first scintillation light upon receiving first incident radiation, the first incident radiation being incident on a first cross-sectional area, generating second scintillation light upon receiving second incident radiation, the second incident radiation being incident on a second cross-sectional area, the second cross-sectional area being, different than the first cross-sectional area, preventing diffusion of the first scintillation light into the second cross-sectional area, the second cross-sectional area extending in a direction parallel to a propagation direction of the first and second incident radiation, preventing diffusion of the second scintillation light into the first cross-sectional area, the first cross-sectional area extending in the direction parallel to the propagation direction of the first and second incident radiation, converting the first scintillation light to a first electric signal, and concerting the second scintillation light to a second electric signal.

### Advantageous Effects of Invention

According to the present disclosure, it is possible to obtain an excellent effect by which the accuracy of the photon counting of the radiation can be improved.

### BRIEF DESCRIPTION OF DRAWINGS

FIG. 1 is a block diagram illustrating an example of a functional configuration related to a radiation detection device according to a first embodiment of the present disclosure.

In FIG. 2A, a diagram schematically illustrating a relation between a scintillator plate and an imaging element according to the first embodiment of the present disclosure is shown.

In FIG. 2B, a diagram schematically illustrating a relation between a scintillator plate and an imaging element according to the first embodiment of the present disclosure is shown.

FIG. 3A is a diagram schematically illustrating an example of a method of manufacturing the scintillator plate according to the first embodiment of the present disclosure.

FIG. 3B is a diagram schematically illustrating an example of a method of manufacturing the scintillator plate according to the first embodiment of the present disclosure.

FIG. 3C is a diagram schematically illustrating an example of a method of manufacturing the scintillator plate according to the first embodiment of the present disclosure.

FIG. 4 is a conceptual diagram illustrating an example of a basic configuration of the imaging element according to the first embodiment of the present disclosure.

FIG. 5 is a schematic diagram illustrating an example of a circuit configuration of a pixel according to the first embodiment of the present disclosure.

FIG. 6A is a conceptual diagram illustrating an example of a functional configuration of a determination circuit according to the first embodiment of the present disclosure.

FIG. 6B is a conceptual diagram illustrating an example of an operation of a determination circuit according to the first embodiment of the present disclosure.

FIG. 7A is a diagram schematically illustrating an example of a radiation detection device according to the related art including a scintillator plate which is not partitioned.

FIG. 7B is a diagram schematically illustrating an example of the radiation detection device according to the first embodiment of the present disclosure.

FIG. 8A is a diagram schematically illustrating a cull reading in a case where the scintillator plate according to the first embodiment of the present disclosure is included, and a cull reading in a case where other scintillator plate (the scintillator plate in FIG. 7A) is included.

FIG. 8A is a diagram schematically illustrating a cull reading in a case where the scintillator plate according to the first embodiment of the present disclosure is included, and a cull reading in a case where other scintillator plate (the scintillator plate in FIG. 7A) is included.

FIG. 9 is a diagram schematically illustrating a pixel array unit (a pixel array unit in which the pixels are arrayed such that only the pixel being in contact with the cross-section of the scintillator can receive the light) according to a second embodiment of the present disclosure.

FIG. 10 is a diagram schematically illustrating a pixel array unit (a pixel array unit in which pixels having a size similar to the area of the cross-section of the scintillator are arrayed) according to a third embodiment of the present disclosure.

FIG. 11 is a diagram schematically illustrating a detection unit (a detection unit which outputs a signal per the detection unit by summing the outputs of a plurality of pixels arrayed to face to the cross-section of the scintillator) according to a fourth embodiment of the present disclosure.

FIG. 12 is a schematic diagram illustrating an example of a detection unit according to a fifth embodiment of the present disclosure.

FIG. 13 is a schematic diagram illustrating an example of a circuit configuration of a pixel according to the fifth embodiment of the present disclosure.

FIG. 14 is a conceptual diagram illustrating an example of a basic configuration of an imaging element according to a sixth embodiment of the present disclosure.

FIG. 15 is an example of a perspective view of a scintillator element and a detection unit according to the sixth embodiment of the present disclosure.

FIG. 16 is an example of a sectional view of the detection unit according to the sixth embodiment of the present disclosure.

FIG. 17 is a schematic diagram illustrating a configuration example of a light receiving unit according to the sixth embodiment of the present disclosure.

FIG. 18 is a block diagram illustrating a configuration example of a detection circuit according to the sixth embodiment of the present disclosure.

FIG. 19A is a schematic diagram illustrating an example of an X-ray scanner which performs a photon-count type detection (a photon-count type X-ray scanner) by applying the embodiments of the present disclosure.

FIG. 19B is a schematic diagram illustrating an example of an X-ray scanner which performs a photon-count type detection (a photon-count type X-ray scanner) by applying the embodiments of the present disclosure.

FIG. 20A is a schematic diagram illustrating an example of a detector of an X-ray CT apparatus to which the embodiments of the present disclosure are applied.

FIG. 20B is a schematic diagram illustrating an example of a detector of an X-ray CT apparatus to which the embodiments of the present disclosure are applied.

FIG. 21A is a schematic diagram illustrating an example of a detector of a gamma camera to which the embodiments of the present disclosure are applied.

FIG. 21B is a schematic diagram illustrating an example of a detector of a gamma camera to which the embodiments of the present disclosure are applied.

### DESCRIPTION OF EMBODIMENTS

Hereinafter, the embodiments of the present disclosure (hereinafter, referred to as embodiments) will be described. The description will be performed in the following order.
1. First Embodiment (A Radiation Detection Control: An Example of Imaging Elements to Which Partitioned Scintillators are Bonded)
2. Second Embodiment (A Radiation Detection Control: An Example of Improving a Time Resolution by Disposing the Pixels Only on a Region Facing the Partitioned Scintillator)
3. Third Embodiment (A Radiation Detection Control: An Example of Improving a Time Resolution by Disposing One Analog Pixel on a Region Facing the Partitioned Scintillator)
4. Fourth Embodiment (A Radiation Detection Control: An Example of Improving a Time Resolution by Adding Outputs of a Plurality of Pixels Through CCD Transfer)
5. The Fifth Embodiment (A Radiation Detection Control: An Example of Adding an Amount of Electric Charge of a Plurality of Pixels)
6. The Sixth Embodiment (A Radiation Detection Control: An Example of Laminating a Substrate on Which Pixels are Provided and a Substrate on Which a Detection Circuit is Provided)
7. An application example of the present disclosure.

### 1. First Embodiment

### Example of Functional Configuration of Radiation Detection Device

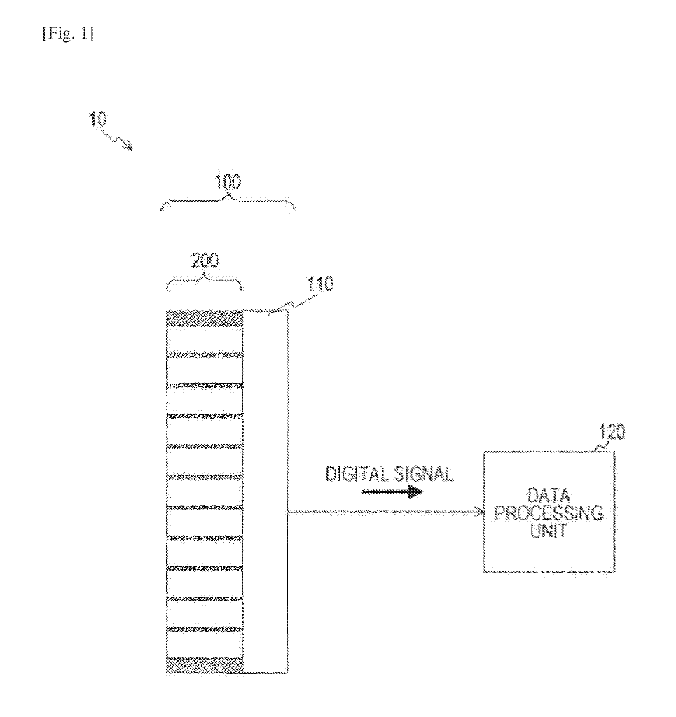

FIG. 1 is a block diagram illustrating an example of a functional configuration related to a radiation detection device 10 according to the first embodiment of the present disclosure.

The radiation detection device 10 illustrated in FIG. 1 is an imaging device that detects radiation by counting photons using a Complementary Metal Oxide Semi-conductor (CMOS) sensor. The radiation detection device 10 includes a detector 100 and a data processing unit 120.

The detector 100 detects radiation by a semiconductor imaging element, and includes a scintillator plate 200 and an imaging element 110.

The scintillator plate 200 absorbs the energy of the radiation such as an electron beam or an electromagnetic wave to emit fluorescent light (scintillation light). The scintillator plate 200 is disposed adjacent to an imaging surface (a surface where the imaging element is provided) of the imaging element 110. In addition, the scintillator plate 200 is finely partitioned in a direction perpendicular to the incident direction of the radiation (vertical direction in Drawing) such that the scintillation light generated by the incident radiation is not diffused and incident on the imaging element 110. That is, in the scintillator plate 200, the scintillator is finely partitioned in a direction where the pixels are disposed in matrix form in the imaging surface of the imaging element 110, such that the incident direction of the radiation is orthogonal to the imaging surface of the imaging element 110. In FIG. 1, dividers for each partition (scintillator) are indicated by regions marked with grey in the scintillator plate 200, each of the partitions (scintillators) are indicated as white rectangles in the scintillator plate 200.

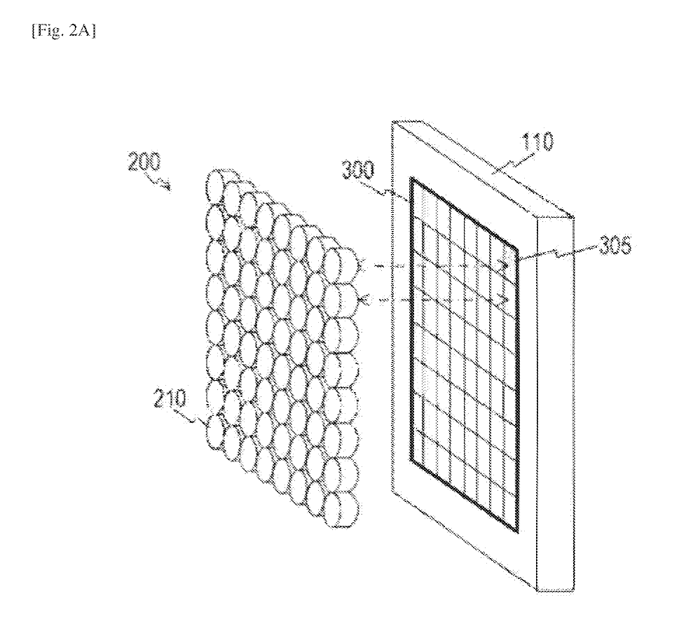

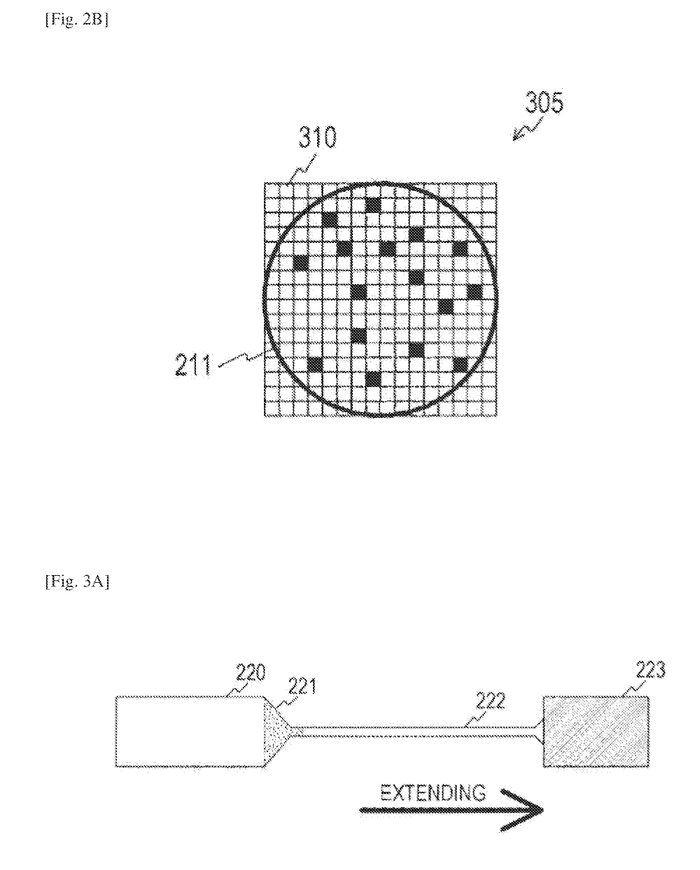

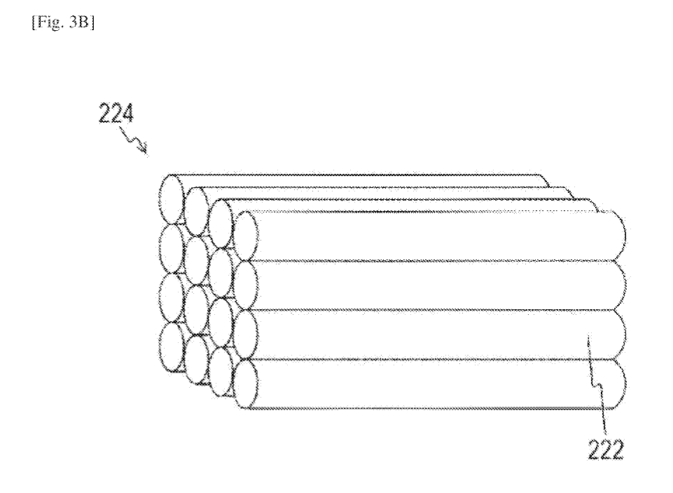

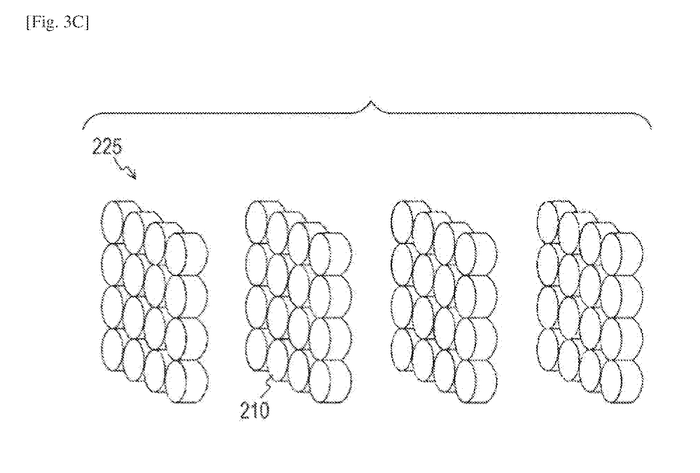

Here, an example of a method for manufacturing the scintillator plate 200 partitioned in this way will be described with reference to FIG. 3A to FIG. 3C. In addition, the description will be made under the assumption that the scintillator plate 200 is configured of the scintillator for detecting the radiation of the electromagnetic wave (X-ray, gamma-ray) in the first embodiment of the present disclosure. Moreover, the scintillator plate 200 is an example of a group of scintillators according to claims of the present disclosure.

The imaging element 110 photo-electrically converts the received light to the electric signal. The imaging element 110, for example, is realized by the Complementary Metal Oxide Semiconductor (CMOS) sensor. In addition, since the imaging element 110 is realized by the CMOS sensor, a cull reading is possible. Therefore, the less the number of rows of the output data of the pixel to be read is, the higher the frequency of the exposure (frame rate (fps)) becomes.

Moreover, in the first embodiment of the present disclosure, the imaging element 110 supplies a binary value (0 or 1) which indicates a presence of the photon incident on the pixel to the data processing unit 120. In this way, in the imaging element 110, the pixel having a high sensitivity (a photon counting type digital pixel) and a detection circuit having a high sensitivity are disposed such that the result of the photon counting of the scintillation light is output as the binary value (digital value). Moreover, since the data output from the imaging element 110 is a digital value, the handling of the signal for the supply of the data to the data processing unit 120 with a better noise immunity becomes easier.

Moreover, in the first embodiment of the present disclosure, the imaging element 110 supplies a binary value (0 or 1) which indicates a presence of the photon incident on the pixel to the data processing unit 120. In this way, in the imaging element 110, the pixel (a photon counting type digital pixel) from which the result of the photon counting of the scintillation light is output as the binary value (digital value) is disposed. Moreover, since the data output from the imaging element 110 is a digital value, the handling of the signal for the supply of the data to the data processing unit 120 with a better noise immunity becomes easier.

The data processing unit 1120 analyzes the detection target based on the digital value supplied from the imaging element 110. For example, the data processing unit 120 calculates a total number of the simultaneously generated scintillation light based on the digital value output from the imaging element 110, and specifies the energy of the radiation by this total number.

In addition, the data processing unit 120 holds information for specifying which pixel receives the scintillation light generated from which partition (pixel specify information), and calculates the total number of scintillation light per each partition based on this information. That is, the data processing unit 120 analyzes the signal supplied from the imaging element 110 based on the pixel specify information for specifying the pixel that receives the scintillation light per each scintillator (partition), to analyze the incident position (partition position) and the energy of the radiation.

Furthermore, it is desirable for the data processing unit 120 to specify a pixel in which the dark current is increased due to radiation damage, and to mask and remove the pixel from the calculation of summing the scintillation light to correct summed value.

In a case where any pixel is damaged by the radiation, the dark current is increased in the pixel, even in a dark state in which the radiation is not incident, the pixel becomes a defective pixel that continues to discharge (output) “1”. Such a defective pixel can he detected and specified by performing the calibration by the data processing unit 120 in the dark state. In a case where the defective pixel exists, it is desirable to exclude the output of that pixel from the output counting, and correct the radiation intensity according to the number of defective pixels for each scintillator partition. For example, when the total number of pixels in a certain scintillator partition is S, the number of defective pixels is D, the data processing unit 120 performs the correction of multiplying the total counting value by (S−D)/S.

Next, a relation between the scintillator plate 200 and the imaging element 110 will be described with reference to FIG. 2A and FIG. 2B.

### Example of Relation Between Scintillator Plate and Imaging Element

In FIG. 2A and FIG. 2B, diagrams schematically illustrating the relation between the scintillator plate 200 and the imaging element 110 according to the first embodiment of the present disclosure are shown.

In FIG. 2A, a diagram is shown which illustrates a state that the scintillator plate 200 provided to be bonded (be adjacent) to the imaging surface of the imaging element 110 is separated from the imaging element 110. In addition, in FIG. 2B, a diagram is shown which illustrates the relation between one scintillator (one partition) in the scintillator plate 200 and the pixel provided on the imaging element 110.

The scintillator plate 200, as illustrated in FIG. 2A, for example, is made of a bundle of cylinder-shaped scintillators. In the first embodiment of the present disclosure, the individual scintillator (scintillator 210) is realized by the scintillating fiber. In addition, the grey regions of the scintillator plate 200 illustrated in FIG. 1 are corresponding to the intervals between the scintillators 210 in FIG. 2A. In addition, the scintillating fiber is made by melting and stretch glass or plastic (plastic scintillator) in which scintillation materials such as bismuth germanate (BGO: Bi4Ge3O12) using a laser or high-temperature heater. The scintillating fiber, similar to optical fiber by glass, can be processed with high precision to obtain a cylinder-shaped fiber having a fine diameter of tens of micrometers by stretching. The method of manufacturing the scintillator plate 200 will be described by FIG. 3A to FIG. 3C, and a detailed description will not be repeated here.

Furthermore, in the first embodiment of the present disclosure, the description will be made under the assumption that the diameter of the individual scintillator (scintillator 210) in the scintillator plate 200 is 40 micrometers and the pixel size of the imaging element 110 (pixel 310) in the imaging surface is 2.5 micrometers angle (2.5 micrometers vertically and horizontally). In addition, the assumption is that, in the imaging element 110, 128 rows*128 columns of pixels are arrayed in the region where the pixels 310 are arrayed (pixel array unit 300).

in this case, 8 rows*8 columns of scintillators 210 are provided with respect to 128 rows*128 columns of pixels. That is, the pixels facing the cross-section (light output surface facing the imaging element) of one scintillator 210 are arrayed in 16 rows*16 columns. Moreover, if a group of pixels facing one scintillator 210 is set to one detection unit, the imaging element 110 in which 128 rows*128 columns of pixels are arrayed can be used as the detector configured to have 8 rows*8 columns (total 64) of detection units (detection units 305).

Next, the incident scintillation light in one detection unit 305 will be described with reference to FIG. 2B which schematically illustrates the 16 rows*16 columns of pixels 310 and an edge of the scintillator 210.

In FIG. 2B, 16 rows*16 columns of pixels 310 corresponding to one detection unit 305 are illustrated as 16 rows*16 columns of rectangles, and the edge of the scintillator 210 (edge 211) is illustrated as a circle in a thick line. In addition, in FIG. 2 the pixels on which the scintillation light is incident are illustrated as rectangles colored in black.

In the scintillator plate 200, a space between the scintillator 210 and the scintillator 210 (outside of the edge 211 in FIG. 2B) is configured to have adhesive which includes reflecting agent or the like. In this way, the scintillation light generated in the scintillator 210 is incident only on the pixel 310 facing the cross-section (light output surface) of the imaging element side of the scintillator 210 (pixels illustrated inside of the edge 211 in FIG. 2B).

Here, the number of pixels 310 facing the light output surface of the scintillator 210 (the number of pixels illustrated inside of the edge 211) is assumed to be 192 pixels (approximately three quarters of 256 (16*16)). In this assumption, the measurement of the strength of the scintillation light generated from one photon in the radiation (X-ray or gamma-ray) incident on the scintillator 210 is a binary determination in 192 pixels. That is, when the scintillation light is assumed to be uniformly incident on 192 pixels, the measurement of the strength of the radiation is in 193 gradations including “no incidence of radiation” (all 0).

Furthermore, as illustrated in FIG. 2A, in case of disposing the scintillator plate 200 to the imaging element 110 in which a plurality of pixels are continuously arrayed in matrix form, it may be possible to be used even though an accurate alignment is not performed. Even when the scintillator plate 200 is deviated from the predetermined position in the imaging surface of the imaging element 110, it is possible to detect the deviated position since the output data from the imaging element 110 is in a circular pattern. In addition, even when a shortage of the number of the pixels 310 facing the scintillator 210 in the edge of the scintillator plate 200 occurs by the deviation of the scintillator plate 200, it, is possible to detect the shortage to perform the correction (for example, correcting by a prediction or excluding from the measurement result).

In addition, since the scintillator plate 200 is configured to have a plurality of scintillators 210 in a bundle, the data output from the imaging element 110 has a plurality of circular pattern (a shape like a polka dot). For this reason, if the radiation is incident on the individual scintillator 210, even being incident on the scintillator plate 200 in the same frame, it is possible to appropriately measure respectively.

For example, the output data of the imaging element 110 is obtained by irradiating the uniform radiation on the entire scintillator plate 200 as a calibration before measuring (for example, in the process of manufacturing) such that the scintillation light is generated from all of the scintillator 210. The detection pattern of the scintillation light in the output data obtained in this way has a detection pattern such that a plurality of circular shapes which indicates a position of a light output surface of the plurality of scintillators 210 with respect to the pixel array unit 300 (position of the detection units) are lined up.

The data processing unit 120 generates pixel specify information for specifying the pixels which receive scintillation light per each scintillator (partition) based on the output data in which a plurality of circular shapes are lined up, and holds the pixel specify information, That is, the data processing unit 120 detects the position of the pixels facing each of the scintillators 210 and the position of each of the scintillators 210 in the imaging surface, based on the position of the circular shapes in the image built by the output data, to store the position data in association therewith.

In this way, in the process of measuring the radiation, by the position of the pixels from which the scintillation light is detected, it is possible to identify from which scintillator 210, the scintillation light is generated, and to integrate the scintillation light generated per each scintillator 210. That is, by analyzing the presence or absence of the pixels which outputs the signal determined as “1” in binary determination per each scintillator 210, it is possible to detect the incident position of the radiation by the size of the scintillator 210 as a minimum resolution. In addition, by counting the number of the pixels which outputs the signal determined as “1” in binary determination per each scintillator 210, it is possible to detect the strength of the radiation per each radiation in a case where one radiation (in case of gamma ray, one photon) is assumed to be incident on the scintillator 210.

Furthermore, as illustrated in FIG. 2B, in the first embodiment of the present disclosure, the example in which 192 pixels 310 are facing with respect to the cross-section of one scintillator 210 is described. However, it is not limited thereto. If one pixel 310 which covers at least the entire cross-section is arrayed, the presence or absence of the incident radiation can be detected from the presence or absence of the scintillation light. That is, the number of the pixels facing the cross-section of the scintillator 210 and receiving the scintillation light relates to a measurement accuracy of the light amount (light strength) of the scintillation light generated from the incident radiation, the accuracy of the measurement increases as the number of pixels increases. In addition, since the light amount of the scintillation light increases according to the energy of the radiation (one photon of X-ray or gamma-ray) incident on the scintillator, the radiation energy resolution increases as the number of pixels increases.

In addition, for example, in a case where only dozens of photons as the scintillator light arrive at the pixel array, the photon counting by the binary determination of 192 pixels is highly accurate. However, if 1000 photons arrive at the pixel, most of them discharge (output) “1”. For this reason, the measurement accuracy deteriorates severely. In such a case, it is preferable that a multi-value determination or a gradation determination is performed according to the amount of incident light for each pixel, rather than the performing of the binary determination for determining the absence or presence of the incident light to each pixel. In this way, the number of photons of the incident light for each pixel can be obtained. In the combination of CMOS sensor-type pixel 310 and the determination circuit 400, the multi-value determination or the gradation value can be performed according to the situation or usage. Accordingly, it is possible to deal with the scintillator light emission in a wide range of the amount of light. In addition, it is possible to significantly improve the dynamic range of the measurement of the radiation energy.

Next, an example of the method of manufacturing the scintillator plate 200 will be described with respect to FIG. 3A to FIG. 3C.

### An Example of the Method of Manufacturing the Scintillator Plate

FIG. 3A to FIG. 3C are diagrams schematically illustrating an example of the method of manufacturing the scintillator plate 200 according to the first embodiment of the present disclosure.

In addition, in FIG. 3A to FIG. 3C, each partition (scintillator) is fine scintillating fiber. An example of manufacturing scintillator plate 200 by bundling this fine scintillating fiber will be described.

In FIG. 3A, an example of manufacturing the scintillation fiber having a diameter of each individual scintillator (scintillator 210 in FIG. 2A) in the scintillator plate (scintillator plate 200 in FIG. 2A) is illustrated.

The scintillator 210 is generated by heating and melting to extend a columnar material (columnar material 220) having scintillation characteristics and is capable of being heated and melted, and then, cutting the extended columnar material (scintillating fiber) by a predetermined thickness.

FIG. 3A is a diagram illustrating the process of heating and melting to extend the end portion of the columnar material 220. The columnar material 220 and an extending portion 223 for extending the columnar material 220 are illustrated in FIG. 3A. In addition, in FIG. 3A, the fiber (scintillating fiber 222) generated by extending the columnar material 220 and the heating and melting position (melting position 221) in the columnar material 220 are illustrated.

As illustrated in FIG. 3A, by heating and melting to extend the columnar material 220, a long scintillating fiber having a diameter of scintillator 210 in the scintillator plate 200 is generated.

In FIG. 3B, a bundle of the long scintillating fiber (the scintillating fiber 222 in FIG. 3A) is illustrated (a bundle of scintillating fiber 224). The bundle of scintillating fiber 224 is generated in a bundle by bonding the plurality of scintillating fiber 222. Here, a material having a lower refractive index than that of the scintillator, or a material in which a light reflective material is mixed is used as the adhesive (mediating material). In addition, making a fine wire by repeating the heating and melting to extend such a bundle as illustrated in the bundle of scintillating fiber 224 also can be considered.

In FIG. 3C, there is illustrated a bundle of scintillator plates in which the bundle of long scintillating fibers illustrated in FIG. 3B (a bundle of scintillating fiber 224 in FIG. 3B) is cut in a lengthwise direction by an intended scintillator thickness (predetermined thickness), and the cut surfaces are polished to process into plate shape (scintillator plate 225). The plurality of scintillator plates 225 may be provided in plural depending on the area in the range of the imaging surface of the imaging element 110, and by providing the scintillator 225 depending on the area in the range of the imaging surface of the imaging element 110, the scintillator plate 200 is formed as illustrated in FIG. 2A.

Furthermore, the scintillator 210 can have the diameter and the thickness depending on the detection target (for example, in case of gamma-camera, the thickness is one centimeter or more). According to the method illustrated in FIG. 3A to FIG. 3C, it is possible to easily manufacture the scintillator 210 with various diameters or thicknesses.

In addition, in FIG. 3A to FIG. 3C, the description is made under the assumption that the columnar material 220 is formed of only the material of scintillator. However, a material that has a two-layer structure with a core portion formed of the material of scintillator and a clad portion formed of a low refractive index material or a light reflective material may also be used. By extending this columnar material having two-layer structure, it, is possible to generate a long scintillating fiber the longitudinal direction of which is covered by the low refractive index material or the light reflective material. The scintillating fiber shielded by the low refractive index material or the light reflective material has a high light confinement effect. In addition, in case of the shielded scintillating fiber, for the adhesive used for making the bundle of scintillating fiber, the light refractive index or the light reflectivity may not be considered.

In addition, in FIG. 3A to FIG. 3C, the description is made under the assumption that the interval between the scintillating fibers is bonded. However, it is possible to obtain the effect of confining the light in the fiber with vacuum and air. That is, it is conceivable that the case of scintillating fiber being bonded directly to the imaging element without bonding the scintillating fibers together.

In this way, the separation of the light path formed in the scintillating fiber can be performed by the reflective material or a medium having a refractive index lower than that of the light path medium. In addition, for example, even in a case where the one-layer scintillating fibers are bonded together, if the fiber has a substantially circular shape and the welding surface is small enough to be ignored with respect to the surface of the fiber (inner wall of the light path), it can be considered that the interval between the light path is effectively separated.

Next, the imaging element 110 that receives the scintillation light generated in the scintillator 210 will be described with reference to FIG. 4.

### Exemplary Configuration of Imaging Element

FIG. 4 is a conceptual diagram illustrating an example of a basic configuration of the imaging element 110 according to the first embodiment of the present disclosure.

In FIG. 4, the description is made under the assumption that two vertical control circuits are provided for driving (controlling) in order to speed up the reading.

The image sensor element 110 includes a pixel array unit 300, a first vertical drive circuit 112, a determination circuit 400, a register 114, a second vertical drive circuit 115, and an output circuit 118. Moreover, the determination circuit and the register for processing the pixel signal driven by the second vertical drive circuit 115 is similar to the determination circuit (determination circuit 400) and the register (register 114) for processing the pixel signal driven by the first vertical drive circuit 112. Therefore, the description will not be repeated.

The pixel array unit 300 includes a plurality of pixels (pixel 310) arrayed in two dimensional matrix (n*m). In addition, in the first embodiment of the present disclosure, it, is assumed that the pixels 310 with 128 rows*128 columns are arrayed in the pixel array unit 300. In the pixel array unit 300 illustrated in FIG. 4, a part of pixels 310 with 128 rows*128 columns is illustrated. Half of the pixels (among the pixels 310) arrayed in the pixel array unit 300 (pixels positioned in upper half part of the pixel array unit, 300 in FIG. 4) are wired by control lines (control line 330) from the first vertical drive circuit 112 in a row-by-row basis. On the other hand, the remaining half of the pixels (pixels positioned in lower half part of the pixel array unit 300 in FIG. 4) are wired by control lines from the second vertical drive circuit 115 in a row-by-row basis. The circuit, configuration of the pixel 310 will be described with reference to FIG. 4, the description will not be repeated here.

Furthermore, a vertical signal lines (vertical signal line 341) are wired to the pixels 310 in a column-by-column basis, The vertical signal lines 341 are wired by individual lines separated by each vertical drive circuit to which the pixel 310 is connected. The vertical signal line 341 connected to the pixel to which the control line 330 is wired from the first vertical drive circuit 112, is connected to the determination circuit 400 facing the upper side of the pixel array unit 300. In addition, the vertical signal line 341 connected to the pixel to which the control line 330 is wired from the second vertical drive circuit 115, is connected to the determination circuit 400 facing the lower side of the pixel array unit 300.

The first vertical drive circuit 112 supplies the signal to the pixel 310 via control line 330, and selectively scans the pixels 310 in a row-by-row basis in a sequentially vertical direction (column direction). By performing the selective scanning by the first vertical drive circuit 112 in a row-by-row basis, the signal is output from the pixel 310 in a row-by-row basis. In addition, the control line 330 includes a pixel reset line 331 and a charge transfer line 332. The pixel reset line 331 and the charge transfer line 332 will be described with reference to FIG. 4, The description will not be repeated here.

In addition, the second vertical drive circuit 115 is similar to the first vertical drive circuit 112 except that the pixel 310 to be controlled is different, and will not be described here. By driving the pixels 310 by the first vertical drive circuit 112 and the second vertical drive circuit 115, two rows are selectively scanned substantially at the same time, and the reading from two rows can be performed substantially at the same time.

The determination circuit 400 determines the presence or absence (binary determination) of the photon incident on the pixel 310 based on the signal output supplied from the pixel 310. The determination circuit 400 provided for each vertical signal line 341. That is, at the position facing the upper side of the pixel array unit 300, there are provided 128 determination circuits 400 that are respectively connected to 128 vertical signal lines 341 wired to the pixels (64 rows*128 columns) driven by the first vertical drive circuit 112. In addition, at the position facing the lower side of the pixel array unit 300, there are provided 128 determination circuits 400 that are respectively connected to 128 vertical signal lines 341 wired to the pixels (64 rows*128 columns) driven by the second vertical drive circuit 115.

The determination circuits 400 supply the determination results to the registers 114 connected to each of the determination circuit 400.

The registers 114 are provided for each determination circuit 400, and temporarily keep the determination results supplied from the determination circuits 400. The registers 114 output the kept determination results to the output circuit, 118 during the period of the pixel signal of next row being read (reading period). Moreover, the determination circuit 400 is an example of a conversion unit described in Claims attached hereto.

The output circuit 118 outputs the signals generated by the imaging element 110 to the external circuit.

Here, the reading operation from the imaging element 110 will be described using the numeric value. In the imaging element 110, the reading from each row is performed sequentially and cyclically. As illustrated in FIG. 4, since the reading in two rows (two systems) are performed simultaneously, the reading of 128 rows is completed in one round of 64 times (cycle) reading. The photo diode is reset at the time when the accumulated charges are transferred for the reading. Accordingly, the period between the reading and the reading is an exposure period. The exposure period is also an accumulation period of the photo-electrically converted charges.

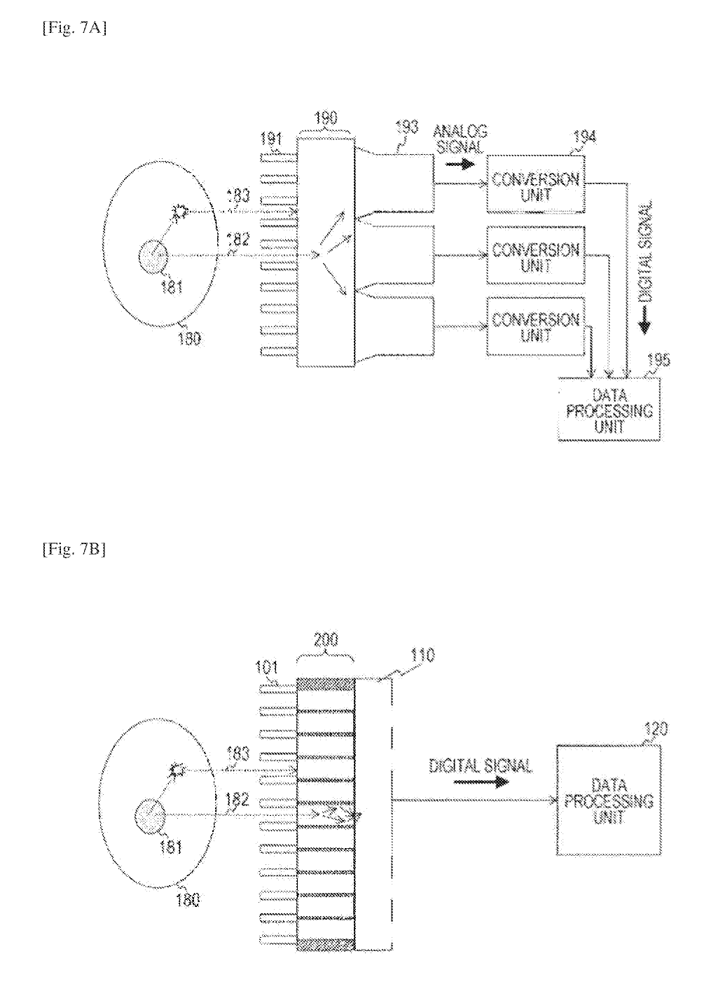

For example, in a case where the time for performing the reading procedure of one row is 5 microseconds, the basic time unit for the exposure period for each pixel is 320 microseconds (5 microseconds*64 cycles) which is for one round of reading. In addition, in this case, 3125 cycles of reading are performed in one second (one second/320 microseconds (0.00032 seconds)). That is, in a case where a single plate scintillator (refer to FIG. 7A) is mounted on the imaging element and the center position of the scintillation light of which the diffusion is large becomes one point, the upper limit of the counts of the radiation is 3125 pcs/sec which is same as the frame rate.

Here, the number of counts of the radiation in a case where the scintillator plate 200 illustrated in FIG. 2A is contacted to the imaging element 110 will be described. Since the scintillator plate 200 illustrated in FIG. 2A is configured to have 8 rows*8 columns (total 64) of scintillators 210, 64 incident light events can be counted at the same time. Since the scintillator plate 200 is 320 micrometers angle, in a case where the frame rate is 3125 fps, the upper limit of the number of counts (C) of the radiation per square millimeter is as following formula 1.

[Math. 1]

C=3125×64/0.32²=1.95×10⁶ (pcs/sec·mm²) Formula 1

As indicated in Formula 1, the detector configured to have the scintillator plate 200 and the imaging element 110 illustrated in FIG. 2A can count more than one million radiations/sec·mm̂2, and can identify the energy.

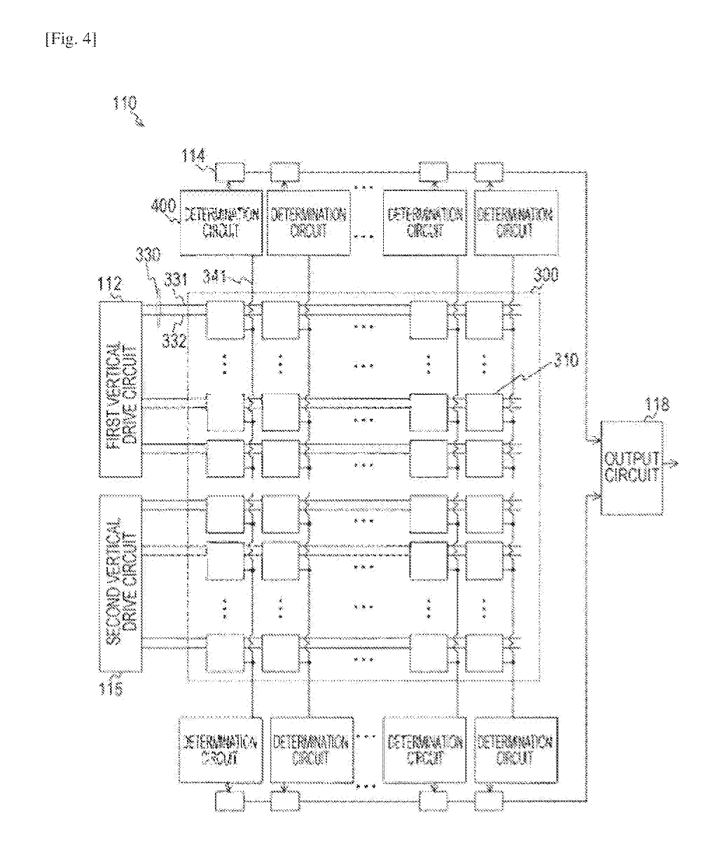

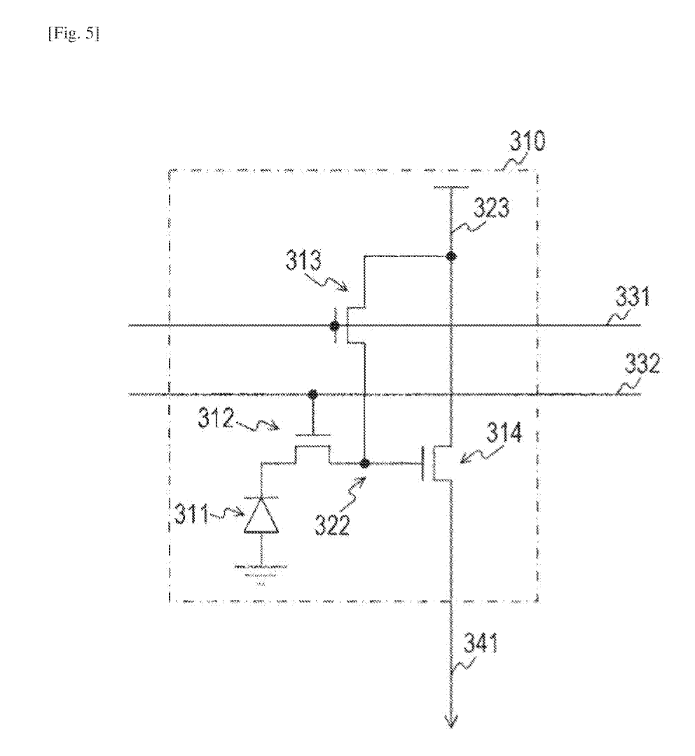

Next, an example of the circuit configuration of the pixel 310 will be described with reference to FIG. 5.

### Example of Circuit Configuration of Pixel

FIG. 5 is a schematic diagram illustrating an example of the circuit configuration of the pixel 310 according to the first embodiment of the present disclosure.

The pixel 310 converts the light signal which is incident light to the electric signal by performing the photo-electric conversion. The pixel 310 amplifies the converted electric signal to output as a pixel signal. The pixel 310, for example, amplifies the electric signal by an FD amplifier having a floating diffusion (FD) layer.

The pixel 310 includes a photo diode 311, a transfer transistor 312, a reset transistor 313, and an amplifier transistor 314.

In the pixel 310, an anode terminal of the photo diode 311 is grounded, a cathode terminal is connected to the source terminal of the transfer transistor 312. In addition, a gate terminal of the transfer transistor 312 is connected to the charge transfer line 332, a drain terminal is connected to a source terminal of the reset transistor 313 and a gate terminal of the amplifier transistor 314 via the floating diffusion (FD 322). Here, the FD322 accumulates the electric charges that were photo-electric converted, and generates an electric signal having a signal voltage corresponding to the amount of accumulated electric charges, Moreover, the FD322 is an example of a charge accumulation unit described in Claims attached hereto.

In addition, a gate terminal of the reset transistor 313 is connected to the pixel reset line 331, a drain terminal is connected to a power line 323 and a drain terminal of the amplifier transistor 314. In addition, a source terminal of the amplifier transistor 314 is connected to the vertical signal line 341.

The photo diode 311 is a photo-electric conversion device which generates electric charges depending on the strength of the light. In the photo diode 311, pairs of electrons and holes are generated by the photons incident on the photo diode 311, and the generated electrons are accumulated. In addition, bias voltage lower than the breakdown voltage is applied to the photo diode 311, and then the photo diode 311 outputs the photo-electric converted charges without an internal gain.

The transfer transistor 312 transfers the electrons generated in the photo diode 311 to the FD 322 according to the signal (transfer pulse) from the vertical drive circuit (the first vertical drive circuit 112 or the second vertical drive circuit 115). The transfer transistor 312, for example, is in a conduction state when the signals (pulses) are supplied from the charge transfer line 332 to the gate terminal thereof. Then, the electrons generated in the photo diode 311 are transferred to the FD 322.

The reset transistor 313 resets the electric potential of the FD 322 according to the signal (reset pulse) supplied from the vertical drive circuit. The reset transistor 313 is in a conduction state when the reset pulse is supplied to the gate terminal via the pixel reset line 331. Then, the electric current flows from the FD 322 through the power line 323. As a result, the electrons accumulated in the floating diffusion (FD 322) are pulled to the power source, the floating diffusion is reset (hereinafter, the electric potential at this time is referred to as reset potential). Moreover, in a case where the photo diode 311 is reset, the transfer transistor 312 and the reset transistor 313 become conduction state simultaneously. As a result, the electrons accumulated in the photo diode 311 are pulled to the power source, the photo diode is reset to the state in which the photon is not incident (dark state). Moreover, the potential flows through power line 323 (power source) is a power source used for resetting or source follower, and for example, is supplied by 3 V.

The amplifier transistor 314 amplifies the potential of the floating diffusion (FD 322), and outputs the signal corresponding to the amplified potential (output signal) to the vertical signal line 341. The amplifier transistor 314, in a case where the potential of the floating diffusion (FD 322) is in the reset state (a case of reset potential), outputs the output signal corresponding to the reset potential (hereinafter, referred to as reset signal) to the vertical signal line 341. In addition, the amplifier transistor 314, in a case where the electrons accumulated by the photo diode 311 are transferred to the FD 322, outputs the output signal corresponding to the amount of the transferred electrons (hereinafter, referred to as accumulation signal) to the vertical signal line 341. Moreover, as illustrated in FIG. 4, in a case where the vertical signal line 341 is shared by a plurality of pixels, a selection transistor may be inserted for each pixel between the amplifier transistor 314 and the vertical signal line 341.

Furthermore, the basic circuit or the operation mechanism of the pixel illustrated in FIG. 5 is similar to an ordinary pixel, a variety of other variations can be considered. However, the pixel assumed in the present disclosure is designed such that the conversion efficiency is significantly higher compared to the pixel in the related art. To that end, the pixel is designed such that the parasitic capacitance of the gate terminal (parasitic capacitance of the FD 322) of the amplifier configuring the source follower (amplifier transistor 314) to be reduced to the utmost limit effectively. This design can be performed, for example, by a method to devise a layout or a method in which the output of the source follower is feedback to the circuit in the pixel (for example, refer to Japanese Unexamined Patent Application Publication No. 5-63468 and Japanese Unexamined Patent Application Publication No. 2011-119441).

The design may be devised such that large enough output signal can be output to the vertical signal line 341 despite that the number of electrons accumulated in the FD 322 is small by reducing the parasitic capacitance like this. The magnitude of the output signal may be sufficiently larger than a random noise of the amplifier transistor 314. if the output signal when one photon is accumulated in the FD 322 is sufficiently larger than the random noise of the amplifier transistor 314, the signal from the pixel is quantized, and it is possible to detect the number of the accumulated photons of the pixel as a digital signal.

For example, in a case where the random noise of the amplifier transistor 314 is approximately 50 microvolt to 100 microvolt, and the conversion efficiency of the output signal is raised up to approximately 600 microvolt/e-, since the output signal sufficiently larger than the random noise, principally one photon can be detected.

Furthermore, if the binary determination of the presence or absence of the incident photon during the unit exposure period is performed, and the result thereof is digitally output, it is possible to make the noise after the output of the output signal by the amplifier transistor 314, to be substantially zero. For example, in a case where the binary determination is performed on the pixel array with 128 rows*128 columns, it is possible to perform photon counting up to 16384 photons (128*128).

Furthermore, in FIG. 5, an example in which one photon can be detected by designing the pixel such that the parasitic capacitance is effectively reduced to the utmost limit is described. However, the present embodiment is not limited thereto. Otherwise, the embodiment can also be implemented by the pixel which amplifies the electrons obtained by the photo-electric conversion, in the pixel. For example, a pixel in which a plural stages of CCD multiplier transfer device is embedded between the photo diode in the pixel and the gate terminal of the amplifier transistor may be considered (for example, refer to Japanese Unexamined Patent Application Publication No. 2008-35015), In this pixel, the electrons photo-electrically converted are multiplied to 10 times within the pixel. In this way, one photon can also be detected by multiplying the electrons within the pixel, and it is possible to use an imaging element in which such pixels are arrayed, as the imaging element 110.

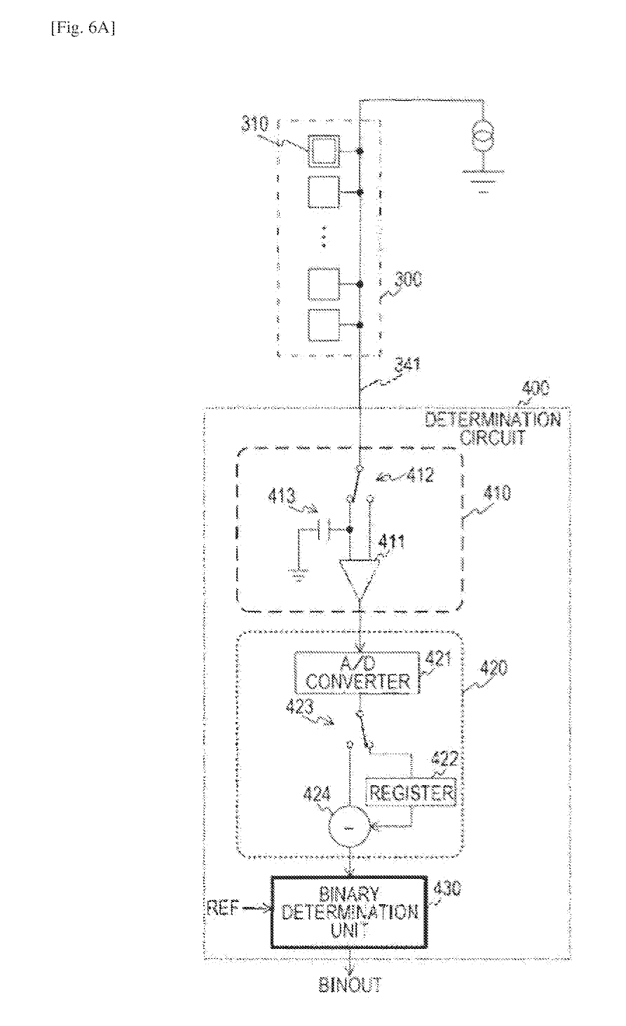

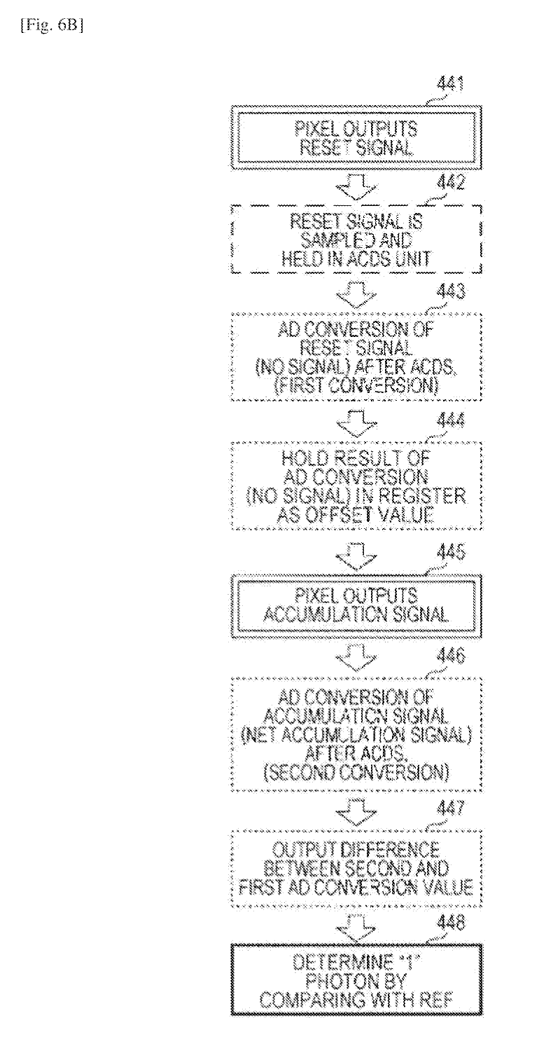

Next, the determination circuit 400 that determines the presence or absence of the incident photons to the pixel 310 based on the output signal supplied from the pixel 310 will be described with reference to FIG. 6A and FIG. 6B.

### Example of Functional Structure of Determination Circuit

FIG. 6A and FIG. 6B are conceptual diagrams illustrating an example of a functional configuration of the determination circuit 400, and an example of an operation of the determination circuit 400 according to the first embodiment of the present disclosure.

In FIG. 6A, an Analog Correlated Double Sampling (ACDS) unit 410, a Digital CDS (DCDS) unit 420 and a binary determination unit 430 are illustrated as the functional configuration of the determination circuit 400.

In addition, in FIG. 6A, the vertical signal line 341 connected to the determination circuit 400, a part of the pixel 310 connected to the vertical signal line 341, and the pixel array unit 300 is illustrated together with the functional configuration of the determination circuit 400.

The ACDS unit 410 performs an offset removal by the analog CDS, and includes a switch 412, a capacitor 413 and a comparator 411.

The switch 412 is a switch that connects the vertical signal line 341 to any of the input terminals which inputs the reference voltage to the comparator 411 or which inputs the signal to be compared to the comparator 411. The switch 412, in a case where the reset signal of the pixel 310 is sampled and held, connects the vertical signal line 341 to the input terminal (left terminal to which the capacitor 413 is connected) which inputs the reference voltage. In addition, the switch 412, in a case where the comparator 411 outputs the result of the analog CDS, connects the vertical signal line 341 to the input terminal (right terminal where there is no capacitor) which inputs the signal to be compared.

The capacitor 413 is a retention capacitor to sample and hold the reset signal of the pixel 310.

The comparator 411 outputs the difference between the signal that is sampled and held and the signal to be compared. That is, the comparator 411 outputs the difference between the reset signal that is sampled and held and the signal that is supplied from the vertical signal line 341 (accumulation signal or reset signal). That is, the comparator 411 outputs the signal in which the noise generated in the pixel 310 is removed such as a kTC noise. The comparator 411, for example, is realized by an operational amplifier having a gain one. The comparator 411 supplies the difference signal to the DCDS unit 420. Here, the difference signal between the reset signal and the reset signal is referred to as “no signal” and the difference signal between the reset signal and the accumulation signal is referred to as “net accumulation signal”.

The DCDS unit 420 performs the noise removal by the digital CDS, and includes an Analog Digital (AD) converter 421, a register 422, a switch 423 and a subtractor 424.

The AD converter 421 AD converts the signal supplied from the comparator 411.

The switch 423 is a switch that switches the supply destination of the signal generated by the AD converter 421, after AD conversion. The switch 423, in a case where the AD converter 421 outputs the result of AD conversion (digital no signal), “no signal”, supplies this “no signal” to the register 422 to be latched (held) to the register 422. Accordingly, the offset value from the comparator 411 and AD converter 421 is held in the register 422. In addition, the switch 423, in a case where the AD converter 421 outputs the result of the AD conversion (digital net accumulation signal), “net accumulation signal”, supplies this signal to the subtractor 424.

The register 422 holds the result of the AD conversion of “no signal”. The register 422 supplies the held result of AD conversion of “no signal” (digital “no signal”) to the subtractor 424.

The subtractor 424 subtracts the value of the digital “no signal” from the value of the digital “net accumulation signal”. The subtractor 424 supplies the result of the subtraction (net digital value) to the binary determination unit 430.

The binary determination unit 430 performs the binary determination (digital determination). The binary determination unit 430 performs the binary determination of the presence or absence of the incident photons to the pixel 310 by comparing the output of the subtractor 424 (net digital value) and the reference signal (REF), and outputs the result of the determination (“BINOUT” in FIG. 6A and FIG. 6B).

Here, the operation of the determination circuit 400 in case of binary determination of the presence or absence of the incident photons in one pixel 310, will be described with reference to FIG. 6B.

In FIG. 6B, a flow chart indicating an example of operation of the determination circuit 400 is illustrated. Here, the frame indicating each procedure in the flow chart illustrated in FIG. 6B, is corresponding to each frame surrounding each configuration illustrated in FIG. 6A. That is, the procedure indicated by a frame with a double line illustrates the procedure of the pixel 310, the procedure indicated by a frame with a long dot line illustrates the procedure of the ACDS unit 410, the procedure indicated by a frame with a short dot line illustrates the procedure of the DCDS unit 420, and the procedure indicated by a frame with a thick solid line illustrates the procedure of the binary determination unit 430. In addition, for the convenience of the description, ACDS processing by the ACDS unit 410 is not illustrated, and will be described together with the procedure of the AD conversion by the DCDS unit 420.

First, in the pixel in the selected row (pixel 310), the electric potential of the gate terminal of the amplifier transistor 314 (potential of the FD 322) is reset and the reset signal is output to the vertical signal line 341 (STEP441).

Subsequently, the reset signal output from the pixel 310 is sampled and held by the capacitor 413 in the ACDS unit 410 (STEP442). Then, the difference signal (“no signal”) between the reset signal sampled and held and the reset signal output from the pixel 310 is AD converted by the AD converter 421 in the DCDS unit 420 (STEP443). In addition, in the AD converted “no signal”, the noise generated by the comparator 411 and the AD converter 421 is included, a value to offset this noise is digitally detected. Then, the result of the AD conversion, “no signal” is held in the register 422 as the offset value (STEP444).

Subsequently, in the pixel 310, the electrons accumulated in the photo diode 311 are transferred to the FD 322, the accumulation signal is output from the pixel 310 (STEP445). Then, the difference signal (net accumulation signal) between the reset signal sampled and held and the accumulation signal output from the pixel 310 is AD converted by the AD converter 421 in the DCDS unit 420 (STEP446). In addition, in the result of this AD conversion, the noise generated by the AD converter 421 and the comparator 411 is included.

Then, by the subtractor 424, the value in which the value of the result of the AD conversion, “no signal” (first conversion) held in the register 422 is subtracted from the value of the result of the AD conversion, the “net accumulation signal” (second conversion) is output (STEP447). In this way, the noise (offset component) caused by the comparator 411 and the AD converter 421 is cancelled, and the digital value of only the accumulated signal output from the pixel 310 (net digital value) is output.

Then, the net digital value output from the subtractor 424 and the reference signal (REF) are compared by the binary determination unit 430 (STEP448) The reference signal (REF) is set to a value near to the intermediate value between the digital value of the signal output from the pixel 310 (no signal) when there is no incident photon, and the digital value of the signal output from the pixel 310 (no signal) when the incident photons are present (for example, the intermediate value “50” between “0” and “100” is the reference signal). In a case where the value of the digital value output from the subtractor 424 (the digital value of only the accumulation signal output from the pixel 310) exceeds the value of the reference signal (REF), the signal of a value “1” (BINOUT) is output as the “incident photon is present”. On the hand, in a case where the value of the digital value output from the subtractor 424 does not exceed the value of the reference signal (REF), the signal of a value “0” (BINOUT) is output which means “no photon is incident”. That is, from the imaging element 110, the presence or absence of the incident photon is output as the digital value (0 or 1) of the result of the binary determination.

In addition, in FIG. 6A and FIG. 6B, the description is made under the assumption of two value determination (binary determination) such as “incident photon is present” and “there is no incident photon”. However, a determination with two values or more may be performed by preparing the reference signal (REF) of a plurality of systems. For example, preparing two systems of reference signal (REF), the reference signal in one system is set to the intermediate value between the digital value when the number of photons is “0” and the digital value when the number of photons is “1”. In addition, the reference signal in the other system is set to the intermediate value between the digital value when the number of photons is “1” and the digital value when the number of photons is “2”. In this way, three determinations in which the number of photons is “0”, “1” and “2” can be performed, and the dynamic range of the imaging can be improved. In addition, in this multi-value determination, since the influence due to the variation of the conversion efficiency per each pixel is increased, it is necessary to perform the manufacturing at a higher accuracy than the in the two-value determination. However, it is similar to the case of binary determination which determines only the presence or absence of the incident photon (0 or 1) from the signal generated the pixel, in the point that the signal generated from the pixel is treated as a digital output.

In this way, in the imaging element 110, since the signal output from the pixel 310 is determined as a digital value in the determination circuit 400, the influence due to the noise during the transmission can almost completely be eliminated compared to the imaging dement in the related art using the signal treated as an analog output (in case of data with 10 bits, 1024 gradations).

Next, the effects of the scintillator plate 200 will be described with reference to FIG. 7A and FIG. 7B, which comparatively illustrate the radiation detection device in the first embodiment of the present disclosure including the scintillator plate 200 and the other radiation detection device including other scintillator plate.

### Example of Effects

FIG. 7A and FIG. 7B are diagrams schematically illustrating an example of the radiation detection device 10 according to the first embodiment of the present disclosure and an example of a radiation detection device according to the related art including a scintillator plate which is not partitioned.

Here, as an example, the description will be made assuming a gamma ray detector in the Single Photon Emission Computed Tomography (SPECT) apparatus which is used for obtaining a bio-distribution of the gamma ray source from the position information of the radiated gamma-ray by introducing a small amount of gamma ray source such as technetium into the human body. In addition, the basic structure and the procedure of the signal processing of the SPECT apparatus described in, for example, Japanese Unexamined Patent Application Publication No. 2006-242958 and Japanese Unexamined Patent Application Publication (Translation of PCT Application) No. 2006-508344 are used and will not be described in detail because the present disclosure relates to the gamma ray detector.

FIG. 7A, an example of a radiation detection device in the related art including a scintillator plate which is not partitioned and a photomultiplier tube is illustrated. In detecting the gamma ray, a device in which the single-plate scintillator which is not partitioned as illustrated in FIG. 7A and the photomultiplier tube are combined, is used in the related art.

In FIG. 7A, as a configuration of the radiation detection device in the related art that detects the gamma ray source (gamma ray source 181) incorporated into the human body (human body 180), a collimator 191, the scintillator 190, the photomultipliers 193, conversion units 194 and the data processing unit 195 are illustrated.

The collimator 191 passes only the gamma ray perpendicularly incident on the gamma ray incident surface of the scintillator 190 and blocks the gamma ray incident in an oblique direction. The collimator 191, for example, is formed of a lead plate on which a large number of small holes are opened.

The scintillator 190 is a single plate scintillator that is different from the scintillator in the first embodiment of the present disclosure (the scintillator plate 200) which is finely portioned.

The photomultiplier tube 193 amplifies the electron generated by the photo-electric conversion using an electron avalanche, and outputs the result of the amplification as an analog pulse. The photomultiplier tube 193 uses high voltage to accelerate the electrons in order to amplify the electrons. The photomultiplier tube 193 supplies the generated analog pulse (an analog signal) to the conversion unit 194. In addition, in the SPECT apparatus, a several tens of photomultiplier tubes 193 are disposed in line. In FIG. 7A, three photomultiplier tubes 193 are schematically illustrated.

The conversion unit 194 converts the analog pulse supplied from the photomultiplier tube 193 to digital, and outputs a digital value per each sampling interval. The conversion unit 194 is provided per each photomultiplier tube 193. The conversion unit 194 supplies the digital value to the data processing unit 195.

In addition, the data processing unit 195 analyzes the detection target as similar to the data processing unit 120 illustrated in FIG. 1. In addition, since the scintillator 190 is a single plate scintillator, the data processing unit 195 finds a center position from the detection result of the scintillation light spread by diffusing, and sets this center position as an incident position of the radiation.

In this way, in the radiation detection device in the related art, the device including the photomultiplier tube is mainly used. In addition, a specific semiconductor such as a cadmium telluride (CdTe) may also be used. However, since any of such detection devices are very expensive, if the detector is configured to include a plurality of those in a line, it takes high cost for just the detectors. Furthermore, since the output of those detectors is an analog pulse, an external apparatus is used for analyzing (measuring, analyzing, counting the number of pulses and the like) the output pulse height in a high speed. For example, in a case of FIG. 7a, the conversion units 194 are used as many as the number of the photomultiplier tube 193. In addition, a strict circuit noise measures is also necessary. For this reason, if the detector is configured using a plurality of detection device such as the photomultiplier tube or the cadmium telluride used in the related art, the size of the external apparatus becomes huge. Thus, a radiation imaging device becomes large and expensive.

Hereinafter, the detection by the radiation detection device in the related art using the gamma ray radiated from the gamma ray source 181, will be described. In FIG. 7A, among the radiated gamma ray, an arrow 182 indicating a trace of the gamma ray not influenced by a scattered ray (primary gamma ray) to the scintillator 190 and an arrow 183 indicating a trace of the gamma ray influenced by a scattered ray (scattered gamma ray) to the scintillator 190, are illustrated. In addition, a trace of the scintillation light generated by the primary gamma ray to the photomultiplier tube 193 is illustrated in a solid arrow with the arrow tail of the arrow 182 as a base point.

The primary gamma ray detected by the radiation detection device is radiated from the gamma ray source 181 as illustrated in the arrow 182, and is incident, on the scintillator 190 without any inhibition for straightness. For this reason, the scintillation light generated by the primary gamma ray has a light amount that reflects the energy of the primary gamma ray.

On the other hand, the scattered gamma ray detected by the radiation detection device is the gamma ray collides with the electrons to be scattered (Compton scattering) after the radiation from the gamma ray source 181, and is perpendicularly incident on the scintillator 190 as illustrated in arrow 183. The scattered gamma ray is information that becomes a noise in which the original positional information is lost. Thus, the energy thereof is lower than that of the primary gamma ray. In addition, the radiation detection device detects not only the primary gamma ray and the scattered gamma ray but also a noise such as cosmic rays from which unusually high energy is detected.

In this way, since both of the noise gamma ray and the desired gamma ray are detected, the SPECT apparatus performs a filtering of the noise signal and the signal of the primary gamma ray among the detected signal by an energy discrimination.

Here, the path of the scintillation light when the single plate scintillator is provided will be described. As illustrated in FIG. 7A, since the scintillator 190 is a single plate, the scintillation light generated by the radiation is diffused in the scintillator 190 and arrives at the imaging surface (a light receiving surface of the photomultiplier tube 193). In FIG. 7A, the scintillation light generated by the primary gamma ray (arrow 182) is illustrated by a solid line arrow with the vicinity of the arrowhead of the arrow 182 as a start point.

In this way, in a case where the scintillator 190 is a single plate which is not partitioned, the scintillation light is detected simultaneously by the plurality of photomultiplier tube 193. In addition, in a case where the photomultiplier tube 193 is a position detection type photomultiplier tube, the scintillation light is detected simultaneously by a plurality of anodes. The data processing unit 195 specifies the energy amount of the gamma rays from the sum of the outputs of the photomultiplier tube 193. The discrimination of the energy of the primary gamma ray and the scattered gamma ray is performed by specifying the amount of energy like this. In addition, the data processing unit 195 specifies an incident position of the gamma ray by the center position of the output of the photomultiplier tube 193. In this way, by accumulating the detection result of the primary gamma ray, the distribution of the gamma ray source in the human body is identified.

In addition, since the scintillator 190 is a scintillator with a single plate, the scintillation light is diffused and is incident on a plurality of photomultiplier tubes 193. For this reason, in a case where a plurality of radiations are incident on the near position of the scintillator plate 200, the range of the pixel on which the scintillation light is incident is overlapped, it is difficult to properly integrate the detection result of the scintillation light per each radiation. That is, it is difficult to identify whether one (one photon) radiation (gamma ray) having strong energy is incident or a plurality of radiations having weak energy are incident.

In FIG. 7B, the radiation detection device 10 is illustrated as a configuration of a radiation detection device that detects the gamma ray source (gamma ray source 181) incorporated into the human body (human body 180). In addition, the radiation detection device 10 will not be described here because the device is similar to that illustrated in FIG. 1 except that the collimators 101 which are vertically extended to the incident surface of the gamma ray from edge position of each scintillator of the scintillator plate 200 are added.

Here, the scintillation light (arrow 182) generated by the primary gamma ray (the solid line arrows with the vicinity of the arrowhead of the arrow 182 as a start point) will be described.

As described in FIG. 7B, the scintillation light generated by the radiation incident on the scintillator plate 200 arrives at the imaging surface (light receiving surface of the imaging element 110) with being diffused to the extent of only the diameter of a partition (scintillator 210) on which the radiation is incident. In this way, in the scintillator plate 200, the degree of the diffusion of the scintillation light is smaller than that of the single plate scintillator (scintillator 190) illustrated in FIG. 7A. That is, the scintillation light is diffused to the extent of only the diameter of the partition.

For this reason, by preparing information for specifying the pixel facing the cross-section of the scintillator in advance, it is possible to integrate the detection result of the scintillation light per each scintillator from the output data of the imaging element 110. That is, the detection result of the scintillation light can be integrated per each incident radiation using the cross-section of the scintillator as a unit of the radiation incident region (a unit of the space resolution), it is possible to perform the photon counting per each radiation.

In this way, since the detection result of (he scintillation light can be separated per each radiation (per each partition) by performing the photon counting of the radiation using the partitioned scintillator, it is possible to improve the accuracy of the radiation counting. In addition, since the detection result of the scintillation light can be integrated per each radiation (per each partition), it is also possible to improve the accuracy of the energy calculation per each radiation. In addition, depending on the degree of the partitioning, it is possible to increase the number of countable radiations per one frame (number of counting).

That is, it is possible to improve a detection resolution in the photon counting of the radiation by performing the photon counting of the radiation using the partitioned scintillator.

Furthermore, in the scintillator plate 200, the pixel region on which the scintillation light is incident can be obtained in advance per each partition (scintillator). The scintillation light diffuses to extent of only the diameter of the partition and the density of the scintillation light is high. Accordingly, even by driving the imaging element 110 by a cull reading, it is also possible to detect the radiation with high accuracy. In addition, when the cull reading is performed, the number of lines (the number of rows) of the pixels of which the signal to be read is decreased, the exposure frequency in the imaging element which is read in a row-by-row basis is increased. When the exposure frequency is increased, the number of detections per unit time is increased and the time resolution is increased.

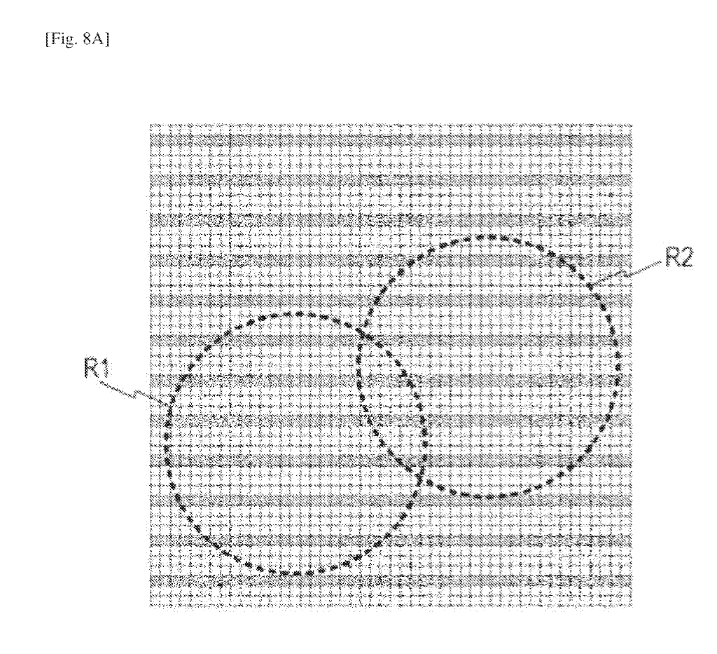

Next, the effect of the time resolution in the scintillator plate 200 will be described with reference to FIG. 8A and FIG. 8B.

FIG. 8A and FIG. 8B are diagrams schematically illustrating the cull reading in a case where the scintillator plate 200 according to the first embodiment of the present disclosure is provided, and the cull reading in a case where other scintillator plate (the scintillator 190 in FIG. 7A) is provided.

In FIG. 8A, there is illustrated a diagram for explaining the relation between the range of the incident position of the scintillation light and the cull reading, in the imaging element in which other scintillator plate (the scintillator 190 in FIG. 7A) is disposed. in addition, in FIG. 8B, there is illustrated a diagram for explaining the relation between the edge of the output surface of the scintillation light (the range of incidence of the scintillation light) and the cull reading, in the imaging element in which the scintillator plate 200 according to the first embodiment of the present disclosure is disposed (the imaging element 110).

In addition, in FIG. 8A and FIG. 8B, 48 rows*48 columns of pixels are illustrated as the pixels in the imaging element. In addition, in FIG. 8A and FIG. 8B, the pixels which are subject to cull reading in the cull reading are illustrated in dotted rectangles, and the pixels which is not subject to cull reading are illustrated in hollow rectangles.

In FIG. 8A, an example of cull reading in which one row of pixels subject to cull reading and 3 rows of pixels that are not subject to cull reading are read alternately is illustrated as an example of the cull reading in case of the imaging element which includes the scintillator 190. In addition, in FIG. 8A, an incident range of the scintillation light generated by the radiation is illustrated by a circular region indicted by a dot line (region R1 and region R2). In addition, in FIG. 8A, two incident ranges of the scintillation light are illustrated by two regions (region R1 and region R2) under the assumption that two radiations are incident. In addition, in FIG. 8A, it is assumed that a part of the two incident rages of the scintillation light are overlapped.

In FIG. 8B, a diagram for explaining the relation between the edge (edge 211) of 3 rows*3 columns (nine) scintillators 210 and the cull reading is illustrated. In addition, FIG. 8B illustrates an example in which four rows for driving the pixels near the center of the scintillator 210 are the rows to be read.

Here, the effect with respect to the time resolution of the scintillator plate 200 will be described. First, the time resolution in a case where the single plate scintillator illustrated in FIG. 8A (the scintillator 190 in FIG. 7A) is provided, will be described.

In the example in FIG. 8A, since there is nothing to limit the diffusion of the scintillation light, the range of pixels that receive the scintillation light (region R1 and region R2) is wide. When the scintillation light is widely diffused like this, the possibility is increased, in which the ranges of pixels that receive the scintillation light generated by the radiation incident on the near position in a same timing is overlapped. In addition, when the cull reading is performed under the state that the scintillation light is widely diffused, the number of the pixels which receive the scintillation light is decreased, the accuracy of the calculation of the center of gravity and calculation of the energy of the radiation is decreased. In particular, when the scintillation light is widely diffused in a case where the number of generated scintillation light is small (the energy of the radiation is small), it is very difficult to improve the accuracy of the calculation of the center of gravity and the calculation of the energy of the radiation.

Like this, in the single plate scintillator (the scintillator 190 in FIG. 7A) in which the scintillation light is widely diffused as illustrated in FIG. 8A, achieving both of culling many rows and detecting the radiation with high accuracy is difficult. That, is, in a case where the single plate scintillator (the scintillator 190 in FIG. 7A) is provided in the imaging element in which the pixels are arrayed in matrix form, it is difficult to improve the time resolution in the radiation detection.

In contrast, when the scintillator is partitioned as illustrated in FIG. 8B, the diffusion of the scintillation light is limited within the partition (within the scintillator 210), the region of the pixels which receive the scintillation light is the region of the pixels facing the light output surface of the scintillator 210. Furthermore, even when the radiations are incident on the near position at the same timing, as long as the radiations are incident on the different scintillators 210 each other, the region of the pixels which receive the scintillation light do not overlap, and can easily be identified.

In addition, if the scintillator is partitioned, when the cull reading is performed, it is possible to make the number of pixels to be read with respect to the scintillation light generated by the radiations incident on one partition (the scintillator 210), to be same per each scintillator 210. In addition, since the scintillation light is not widely diffused, even the number of culled rows is increased, the probability of detecting the scintillation light is increased. That is, in the partitioned scintillator, it is possible to perform the calculation of the center of gravity and the calculation of the energy of the radiation with higher accuracy even the number of culled rows is increased, compared to the case of the single plate scintillator.

In this way, in the partitioned scintillator (the scintillator plate 200), achieving both of culling many rows and detecting the radiation with high accuracy may be possible. That is, in the scintillator plate 200, it is possible to easily improve the time resolution.

In addition, since the CMOS sensor (imaging element 110) in which the photo diode except the API) is used instead of the silicon PMT made of API) is used in the light detection cell, it is possible to microminiaturize the radiation detection unit 305. However, since the output signal of the pixel in the CMOS sensor is extremely weak, the determination circuit. 400 is required to be on-chip separately which digitize the signal using the reference signal REF, and it takes time to perform the signal determination. However, by miniaturizing the light detection sensor, and eventually by microminiaturizing each detection unit 305, the radiation incident frequency to each detection unit 305 is dramatically mitigated. For example, even in a case where the radiation of one million/mm̂2 per one second is incident, if the scintillator is partitioned for each 50 micrometer angle and the detection units 305 are sub-divided according thereto, the number of incident radiation on each detection unit is approximately 1/400, that is approximately 2500 radiations per second. On the partition wall of the scintillator, by confining a light emission pulse into the unit using a reflective material or a low refractive material, and if the emission pulse is detected for each unit, the requirement of the time resolution of each unit is mitigated to 1/400, and then there is no need to worry about the pile-up of the scintillator or the shape of the emission pulse anymore. The detection unit operates at the low voltage of lower than 5V, thus, the dark current at normal temperature is small. Therefore, the aperture ratio or the quantum efficiency is high. Particularly, in the X-ray transmission imaging apparatus and the CT apparatus which require a strict specification in time resolution and space resolution, an advantage of the miniaturization using the CMOS sensor is remarkable, in this case, the area of each partition of the scintillator is desired to be less than 200 micrometer angle, and further it is desired to be 100 micrometer angle.

In this way, according to the first embodiment of the present disclosure, by performing the photon counting of the radiation using the partitioned scintillator, it possible to improve the accuracy in the photon counting of the radiation.

### Second Embodiment

In the first embodiment of the present disclosure illustrated in FIG. 1 to FIG. 8B, the description is made under the assumption that all the pixels arrayed in the pixel array unit are capable of receiving the light. Moreover, regarding the relation between each partition of the scintillator plate (scintillator) and the pixels, a variety of examples can be considered.

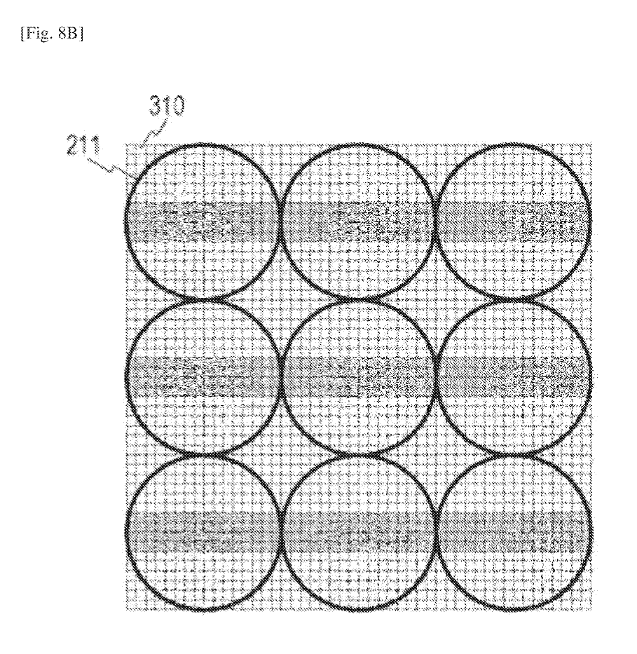

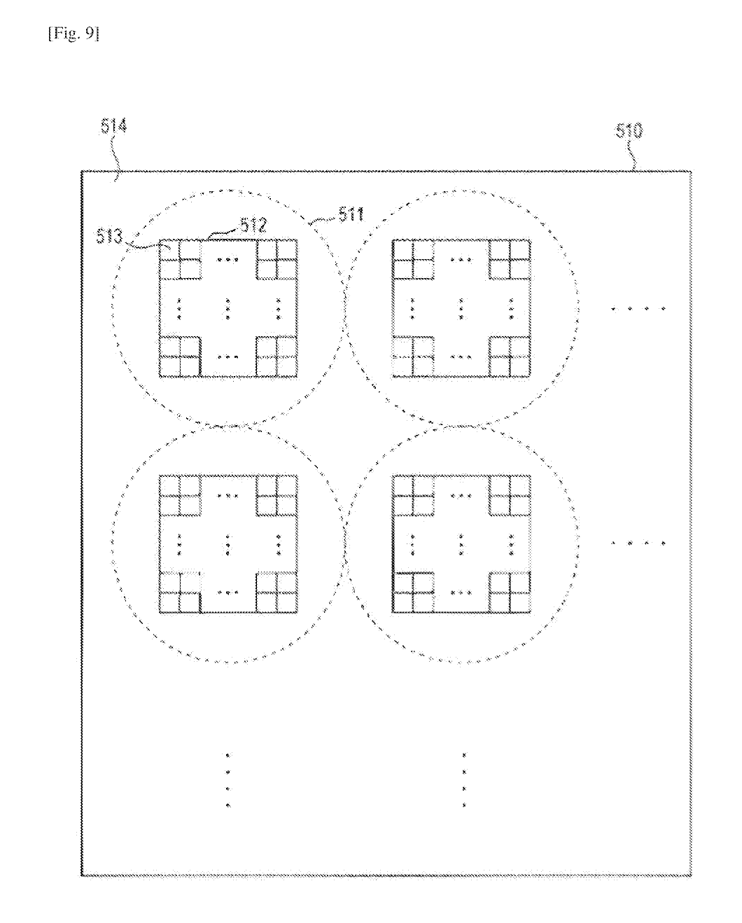

Here, in FIG. 9 to FIG. 11, the relation between each partition of the scintillator plate (scintillator) and the pixels will be described, with the differences from those described in the first embodiment of the present disclosure illustrated in FIG. 1 to FIG. 8B as the second to fifth embodiment of the present disclosure.

Example of arraying the pixels such that only the pixels being in contact with the cross-section of the scintillator can receive the light

FIG. 9 is a diagram schematically illustrating a pixel array unit (a pixel array unit in which the pixels are arrayed such that only the pixels being in contact with the cross-section of the scintillator can receive the light) according to the second embodiment of the present disclosure.

In FIG. 9, a pixel array unit (pixel array unit 510) provided on the imaging element (imaging element 110) instead of the pixel array unit 300 in FIG. 4, is illustrated. Moreover, in the second embodiment of the present disclosure, it is assumed that the diameter of each scintillator realized by the scintillating fiber is approximately 40 micrometers, and the scintillator plate is configured to have 8 rows*8 columns of scintillators. In addition, the size of the pixel is assumed to be 2.5 micrometers angle.

In the pixel array unit 510, a region in which the pixels of 2.5 micrometers angle (pixel 513) are configured to be arrayed in 10 rows*10 columns (detection unit 512) is disposed to match a pitch of the scintillators of 8 rows*8 columns. That is, in the pixel array unit 510, 8 rows*8 columns of detection units 512 are disposed with approximately 40 micrometers pitch. In addition, in FIG. 9, a part of detection units 512 disposed in the pixel array init 510 (2 rows*2 columns) is illustrated together with the dot line circles (edge 511) indicating the edge of the scintillator mounted on the pixel array unit 510.

In the pixel array unit 510, only the pixels arrayed in the detection unit 512 are driven. That is, the pixels arrayed in the region outside the detection unit 512 are not driven and read. For example, in this region outside the detection unit 512 (region 514 in FIG. 9), dummy pixels are arrayed, of which the floating diffusion potential is typically a reset potential. Moreover, since the pixels in the region 514 may be blocked because they are not used.

Here, the performance of the imaging element 110 including the pixel array unit 510 will be described. When mounting (connecting) the scintillator plate on the imaging element 110, it is necessary to align such that the center of the detection unit, 512 and the center of the cross-section (light output surface) of the scintillator (center of the inner side of the edge 511) are substantially matched. Although it takes such an effort, since pixels arrayed in the wasted region is not driven when the imaging element 110 is driven, it is possible to increase the frame rate. That is, it is possible to improve the time resolution by avoiding the unnecessary driving. In addition, as illustrated in FIG. 9, by arraying the pixels on the smaller area than the light output surface of the scintillator, only the pixels on which the scintillation light, is incident can be subject to be driven, it is possible to improve the time resolution.

For example, as similar to FIG. 4, in a case where pixels are driven by two vertical drive circuits, the number of detection units 512 in row direction which are driven by each of the vertical drive circuits is four. That is, the number of rows of the pixel driven each of the vertical drive circuits is 40 rows (four*10 rows). That is, in a case where it takes five micro second for reading one row, time to read one round (time for one frame) is 200 micro second (five micro seconds*40 rows), the frame rate is 5000 fps (one second/200 micro second). In addition, since 8 rows*8 columns scintillator has 320 micrometers angle, the upper limit of the number of radiation counting (C₂) per square millimeter here is as following Formula 2.

[Math. 2]

C₂=5000×64/0.32²=3.12×10⁶ (pcs/sec·mm²) Formula 2

As can be seen when Formula 2 described above is compared to Formula 1 illustrated in FIG. 4, by configuring the pixel array unit such that only the pixel facing the cross-section of the scintillator can be driven, it is possible to increase the number of radiation counting (counting ability). That is, according to the second embodiment of the present disclosure, it is possible to improve the detection resolution of the photon counting of the radiation.

Here, the description is made assuming the case of driving (control) by two vertical drive circuits. However, it may be considered that the vertical drive circuit and the determination circuit may be provided in the surplus region outer side of the detection unit 512 (region 514) per each detection unit 512. In this case, the number of rows of pixels driven by each vertical drive circuit is ten rows, time to read one round (time for one frame) is 50 micro second (five micro second*ten rows), the frame rate is 20000 fps (one second/50 micro second). In this case, the upper limit of the number of radiation counting (C₃) per square millimeter is as following Formula 3.

[Math. 3]

C₃=20000×64/0.32²=1.25×10⁷ (pcs/sec·mm²) Formula 3

As can be seen when Formula 3 described above is compared to Formula 2, if the vertical drive circuit is provided per each detection unit 512, it is possible to increase the number of counting of the radiation.

In FIG. 9, an example of improving the time resolution by arraying the pixels which can receive the light only in the region facing the cross-section of the scintillator and decreasing the number of rows of pixels subject to drive. However, the time resolution can also be improved by making a size of one pixel to be large. Next, an example of arraying the pixels having a wide light receiving surface will be described with reference to FIG. 10 as the third embodiment of the present disclosure.

### 3. Third Embodiment

### An Example of Arraying Pixels Having Sizes Similar to Area of Cross-Sections of Scintillators

FIG. 10 is a diagram schematically illustrating a pixel array unit (a pixel array unit in which pixels having sizes similar to the area of the cross-sections of the scintillators are arrayed) according to the third embodiment of the present disclosure.

In FIG. 10, a pixel array unit (pixel array unit 520) in which imaging elements (imaging element 110) are provided instead of the pixel array unit 300 in FIG. 4 is illustrated. In addition, the pixel array unit 520 is a modification example to the pixel array unit 510 illustrated in FIG. 9. The difference is in that pixels including photo diodes with the sizes similar to the detection units 512 in FIG. 9 (pixels 522) are provided instead of the detection units 512. Therefore, in FIG. 10, the same configurations will be referenced by the same numerals as in FIG. 9, and the description will not be repeated.

The pixel 522 illustrated in FIG. 10, for example, is a pixel including a single photo diode having approximately 25 micrometers angle. The pixel 522 is an analog accumulation pixel in which a number of electrons are accumulated, and from which an output gradation can be obtained by a single pixel. In addition, the floating diffusion and the reset transistor of the pixel 522 are disposed in the region 514 illustrated in FIG. 9. For this reason, in FIG. 10, those circuits (referred to as attached circuit in FIG. 10) are schematically illustrated in rectangle (attached circuit 523) in the region 514 adjacent to the pixel 577.

The pixels 522 are arranged in an array of the same pitch (approximately 40 micrometers) as 8 rows*8 columns scintillator, in the pixel array unit 520. In addition, the circuit to convert the output signal of the pixel (AD conversion circuit) may be disposed so as to be shared by the plurality of pixels in a row-by-row basis with respect to the pixels 522 arranged in an array, or may be provided per each pixel 522. In addition, in a case where the AD conversion circuit is provided per each pixel 522, it is possible to start and finish the exposure (accumulation) of all the pixels substantially simultaneously.

In addition, as illustrated in FIG. 10, in a case where, using the analog accumulation pixel as the pixel, one pixel 522 is provided with respect to one scintillator, it is necessary that one photo diode accumulates a number of electrons, and supplies the signals having potentials corresponding to the accumulation to the AD conversion circuit. That is, it is necessary to supply analog signals to the AD conversion circuit. In addition, when using the analog accumulation pixel, it is desirable that the number of pixels allocated to one scintillator is as small as possible, considering from a view of such an amplifier noise riding on analog signals and the quantization noise of the AD converter. That is, the case where one pixel is provided with respect to one detection unit may be the best from the point of view of noise.

However, as the number of pixels decreases, the area of the photo diode of the pixel increases. When the area of the photo diode increases, it is difficult to transfer the accumulated electric charges to the floating diffusion. Therefore, it is necessary to make the electric charges to be transferred appropriately.

Here, the description will be made assuming that an X-ray having a weak energy (soft X-ray) is incident on the scintillator. Since the number of photons of the scintillation light generated by one photon in the soft X-ray is approximately one hundred, the number of photons incident on the pixels of 25 micrometers angle from the scintillator is several tens. That is, in order to measure the light strength correctly, it is necessary to quickly transfer the several tens of electrons accumulated in the photo diode of 25 micrometers angle, and to convert into the voltage with a high conversion efficiency to be transmitted to the AD converter. In addition, in a case of the circuit configuration illustrated in FIG. 5, it may be conceivable that the transfer can be facilitated by increasing the width of the terminals of the transfer transistor 312. However, in that case, the parasitic capacitance of the floating diffusion (FD 322) becomes very high, the conversion efficiency of the amplifier transistor 314 is decreased. In addition, when the diffusion layer portion of the FD 322 is increased by increasing the width of the terminals, there may be problem of a dark current due to junction leakage.

Therefore, in order to appropriately transfer the several tens of electrons accumulated in photo diode of 25 micrometers angle, it may be conceivable to provide an intermediate node used for transferring only by a buried diffusion layer or a Charge Coupled Device (CCD), between the transfer transistor 312 and the FD 322. In addition, the intermediate node used only for transferring is provided such that the layout shape and the impurity distribution is optimized, in order to mediate the charge transferring from the transfer transistor 312 with a wide width to the very small FD 322.

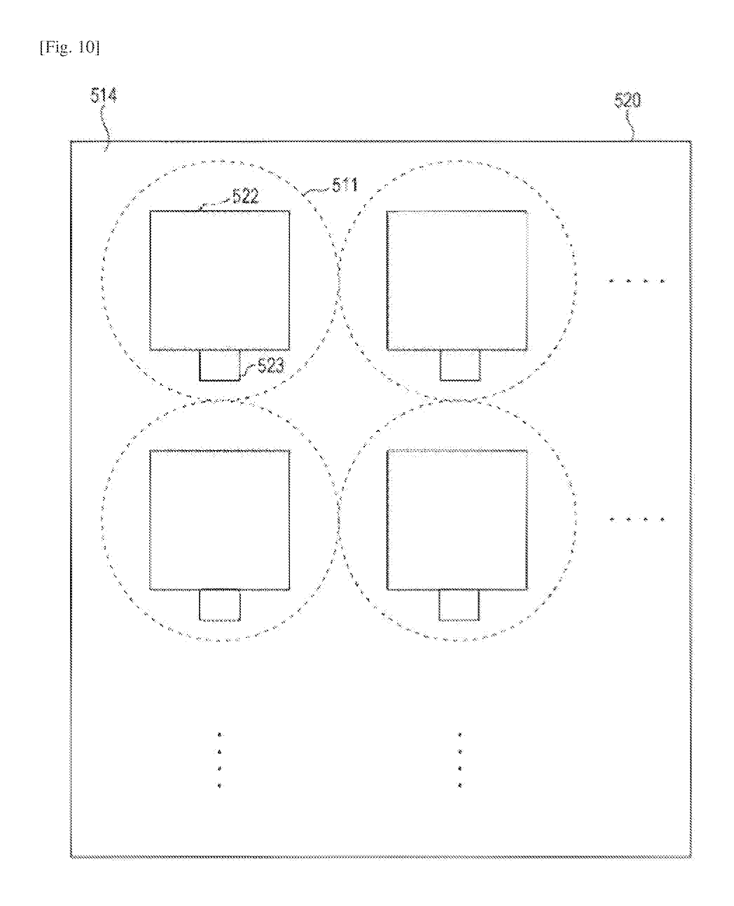

In FIG. 10, an example of improving the detection resolution in photon counting of the radiation by arraying one large analog pixel in one detection unit is described. However, it, is possible to improve the detection resolution in photon counting by configuring each detection unit from a plurality of analog pixels, and summing the outputs from each analog pixel per the unit of each detection unit. Next, an example of summing the outputs per each detection unit will be described with reference to FIG. 11 as the fourth embodiment of the present disclosure.

### 4. Fourth Embodiment

### Example of Summing Outputs of Pixels Per Each Detection Unit

FIG. 11 is a diagram schematically illustrating a detection unit (a detection unit which outputs the signal per the detection unit by summing the outputs of a plurality of pixels arrayed facing to the cross-section of the scintillator) according to the fourth embodiment of the present disclosure.

In addition, the detection unit illustrated in FIG. 11 (detection unit 532) is provided in the pixel array unit instead of the detection unit 512 illustrated in FIG. 9.

In FIG. 11, an example is illustrated, in which the outputs of 4 rows*4 columns pixels arrayed at the position where the cross-section of the scintillator is in contact with is summed, and the signal per each detection unit is output. In the detection unit 532, a plurality of pixels in which the electric charges are transferred by the interline-type Charge Coupled Device (CCD) are arrayed. In addition, in FIG. 11, the pixels are illustrated by 16 pixels in square (pixel 534), a CCD for vertical transfer (vertical transfer registers) is illustrated in rectangle with a downward arrow, and a CCD for horizontal transfer (horizontal transfer registers) is illustrated in rectangle with an arrow pointing right.

The charges accumulated in the pixels of the detection unit 532 are read out to the vertical transfer register all at once, and then, vertically transferred. After the vertical transfer, the charges are collected in the nodes of vertical transfer register and horizontal transfer register of each column (nodes 535 in FIG. 11), to become the summed data in a column-by-column basis.

Then, the pixel data collected in the node 535 per each node are horizontally transferred and collected in one node (node 536), to become the summed data of all the pixels. Then, the summed data are converted into the voltage by the source-follower amplifier 537, and then, threshold determined by a detection determination circuit 538 or the AD converted, to be output as digital data.

A plurality of detection units 532 are provided corresponding to the plurality of scintillators bonded to face the pixel array unit. The plurality of detection units 532 operate simultaneously in a same timing.

In this way, the detection unit 532 which collects the charges from the individual analog pixel to one node by the CCD transfer, converts into the voltage by the source-follower amplifier, and performs AD conversion, has the lowest noise in a case of arraying the plurality of analog pixels facing the cross-section of the scintillators. That is, the imaging element in which the detection units 532 are provided is the imaging element advantageous for the determination of the strength of the light with high accuracy under extremely low illumination.

### 5. Fifth Embodiment

### Example of Performing Addition of FD

In the first embodiment, each of one FD322 and one amplifier transistor 314 (source follower) are provided for each pixel 310 in the detection unit 512. However, the detection unit may have a configuration in which a plurality of pixels shares an FD (floating diffusion) and an amplifier transistor. The detection unit 512 in the fifth embodiment is different from that in the first embodiment on the point that a plurality of pixels shares an FD (floating diffusion) and an amplifier transistor.

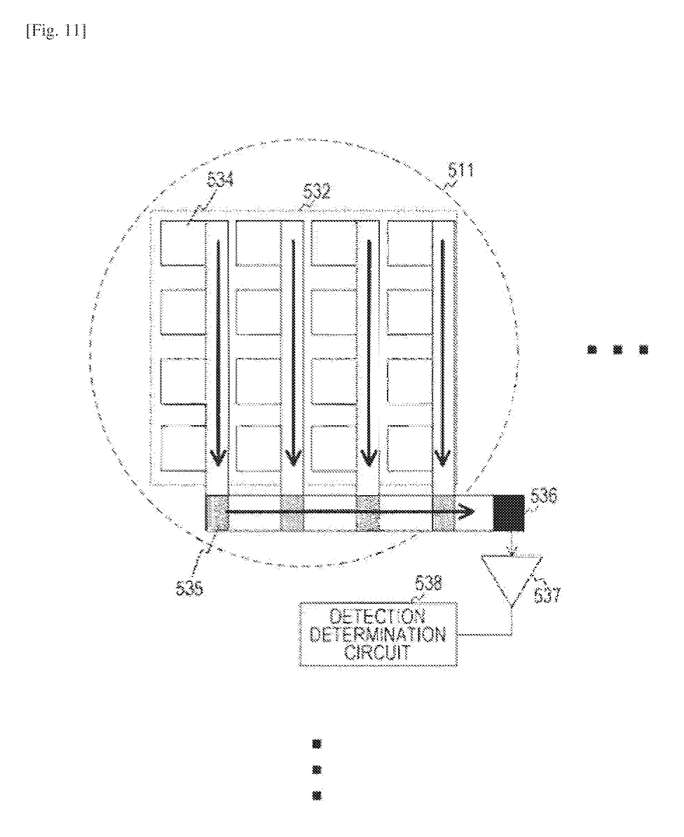

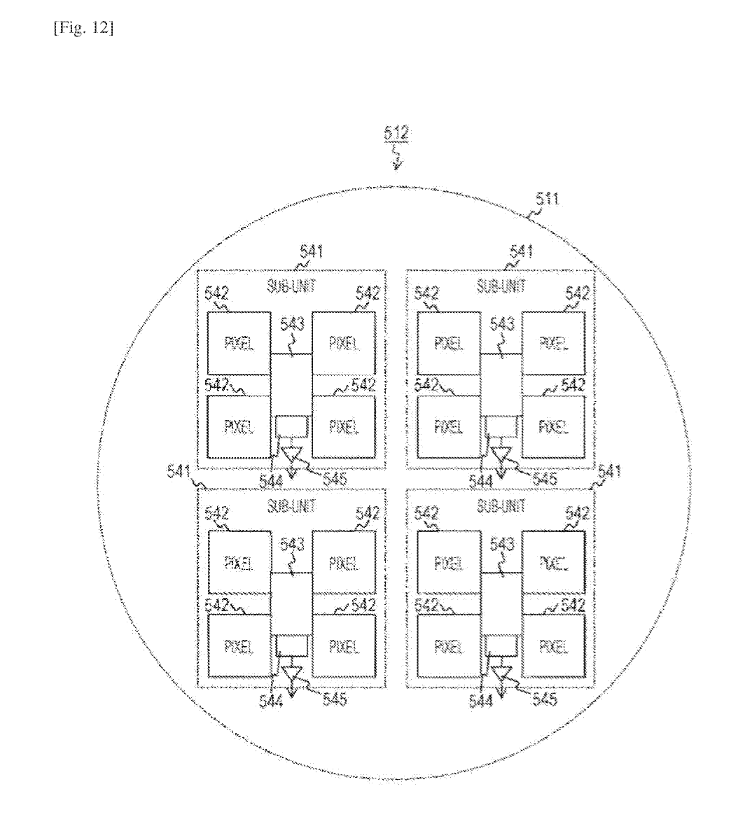

FIG. 12 is a schematic diagram illustrating an example of the detection unit 512 in the fifth embodiment. The detection unit 512 in the fifth embodiment includes a certain number of sub-units 541 (for example, four) instead of a plurality of pixels 310. The sub-units 541 include a plurality (for example, four) of pixels 542, an intermediate node 543, an FD 544, and an amplifier transistor 545.

Each of the pixels 542 in the fifth embodiment is different from the pixel 310 in the first embodiment in the point that each of the pixels 542 does not include the FD and the amplifier transistor 314. The intermediate node 543 is a node to which the reset transistor 313 and the transfer transistor 312 of the pixel 542 are respectively connected.

The FD 544 collects and accumulates the charges which are photo-electric converted by each pixel 542 in the sub-unit 541. The layout of FD 544 is designed in such a manner that the parasitic capacitance is minimized. In this configuration, once the charges from the each pixel 542 are transferred to the intermediate node 543 simultaneously, and subsequently transferred to the FD 544 and the amount of charges is added in units of the sub-unit 541. These transfers are performed by a potential scanning between each of the nodes, and can be performed completely.

The amplifier transistor 545 amplifies the voltage corresponding to the accumulated amount of charges in the FD 544, and output to the determination circuit 400. Moreover, in FIG. 12, the wiring from each amplifier transistor 545 to the determination circuit 400 is not illustrated for the sake of convenience in describing. The determination circuit 400 is formed in an on-chip formation on the surrounding area of the semiconductor element which forms the pixel or on the surplus area between the pixel arrays, similar to the first embodiment.

FIG. 13 is a schematic diagram illustrating an example of a circuit configuration of the pixel 542 in the fifth embodiment. The pixel 542 in the fifth embodiment is different from. the pixel 310 in the first embodiment in the point that the pixel 542 does not include the FD 322 and the amplifier transistor 314. In addition, the drain terminal of the transfer transistor 312 and the reset transistor 313 in the fifth embodiment are connected to the intermediate node 543.

In this way, according to the fifth embodiment of the present disclosure, since the plurality of pixels shares the FD 544 and the amount of charges generated by those pixels are added, the signal voltage can be increased. As a result, to the imaging element 110 can detect the photons with high accuracy.

### 6. Sixth Embodiment

### Example of Laminating the Determination Circuit and the Pixels

In the imaging element 110 in the first embodiment, the pixel 310 and the determination circuit 400 are provided on the same substrate. Here, in recent years, a technology in which circuits formed on two substrates are laminated and connected to each other using a wafer bonding technology in the pre-process of the semiconductor manufacturing process, has been in practical use. Employing this lamination technology, the circuits formed by laminating and having a low resistance and parasitic capacitance which are the same as the usual circuits integrated by on-chip formation, are connected to each other, the weak signal can be transferred. In other words, the circuit laminating by an on-chip can be realized. If the lamination technology is used, it is possible to laminate the substrate on which the pixel 310 is provided and the substrate on which the determination circuit 400 is provided. In this way, the independent operation and the independent control of the circuit on each substrate can be possible, and the peripheral circuit area of the imaging element 110 can be minimized. Therefore, it is possible to easily spread the determination circuit 400 in a wide area. The imaging element 110 in the sixth embodiment is different from that in the first embodiment on the point that the substrates on the which the pixels 310 are provided and the substrate on which the determination circuit 400 is provided are laminated.

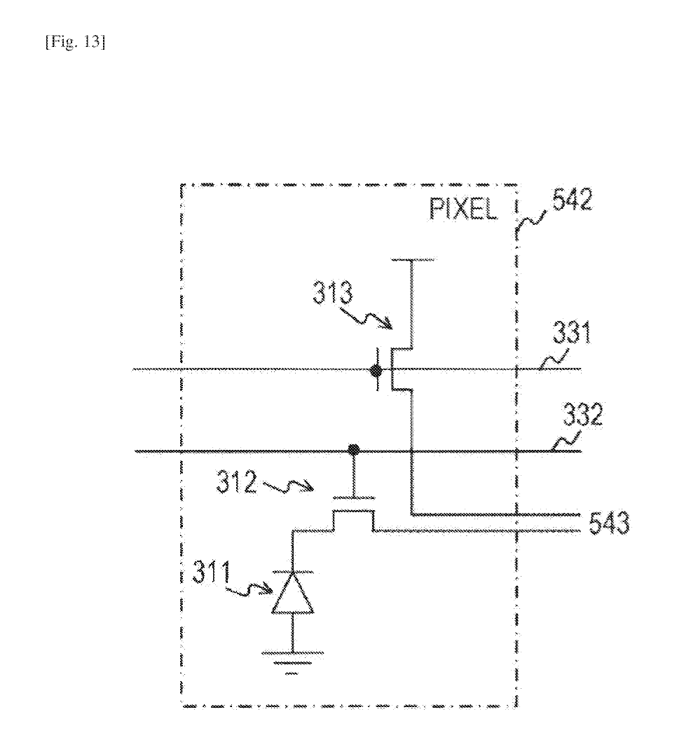

FIG. 14 is a conceptual diagram illustrating an example of a basic configuration of the imaging element 110 according to the sixth embodiment of the present disclosure. The imaging element 110 according to the sixth embodiment includes a pixel drive circuit a plurality of light receiving units 551, a plurality of detection circuits 555, and the output circuit 118. However, since the detection circuit 555 is provided on the substrate other than the substrate on which the light receiving unit 551, the detection circuit 555 is not illustrated in FIG. 14.

Each of the light receiving units 551 includes one or more pixels (for example, 16 pixels). The light receiving units 551 are arrayed in a two-dimensional lattice shape (far example, 4 rows*4 columns=16) in the imaging element 110. As the pixels arrayed in the light receiving unit 551, for example, a back-illuminated type pixel are used, in which the light is illuminated on the back surface where photo diodes are arrayed.

The pixel drive circuit 550 selects and scans the pixels in an order in a unit of light receiving unit 551. The details of the control of the light receiving unit 551 by the pixel drive circuit 550 is similar to that of the first vertical drive circuit 112 except that the pixel drive circuit 550 selects the pixels in a unit of the light receiving unit 551 while the first vertical circuit 112 selects the pixels in a unit of row. In addition, the pixel drive circuit 550 can individually set the exposure time for each light receiving unit 551.

The configuration of the output circuit 118 in the sixth embodiment is similar to that in the first embodiment. Moreover, the output circuit 118 in FIG. 14 is illustrated so as to be connected to the light receiving unit 551. However, actually, the output circuit 118 is connected to the detection circuit 555 disposed on the lower part of the light receiving unit 551 such that the light incident direction is the upward direction.

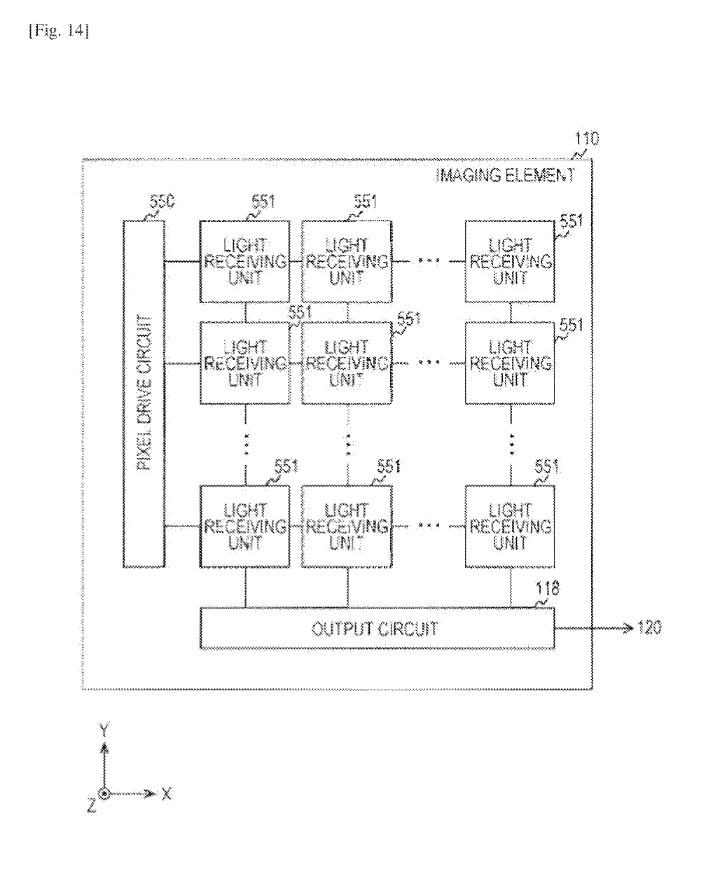

FIG. 15 is an example of a perspective view of a scintillator element 560 and a detection unit 512 according to the sixth embodiment. In the sixth embodiment, the radiation detection device 10 includes a square pole-shaped scintillation element 560 instead of the scintillating fiber. in each of the scintillation elements 560, by the light incident direction of the radiation as the upward direction, a partition wall 561 is disposed on the side surface except the incident surface on the upper side and the bonded surface on the lower side. However, for the sake of convenience, the partition wall 561 is not illustrated in FIG. 15. Moreover, the shape of the scintillation element is not limited to the square pole, the shape may be a triangular pole or a cylindrical pole.

In addition, each of the detection units 512 includes the light receiving unit 551 and the detection circuit 555. The light receiving unit 551 is connected to the adhesive surface of the scintillation element 560, and the detection circuit 555 is provided on the lower layer substrate than the substrate on which the light receiving unit 551 is provided. The detection circuit 555 is a circuit that includes the determination circuit 400 and the register 114 of the first embodiment.

The light receiving unit 551 and the detection circuit 555 are formed on the different semiconductor substrates from each other. However, the substrates are laminated using the wafer bonding technology in the pre-process of the semiconductor manufacturing process. In addition, since the detection circuit 555 is individually installed in each detection unit 512, for example, thus, a simultaneous parallel operation of the detection units all at once is possible.

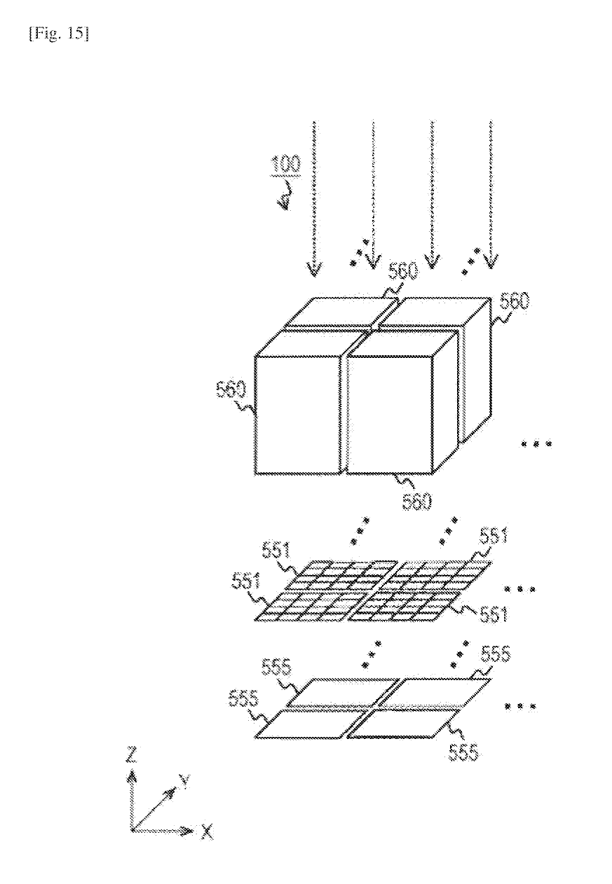

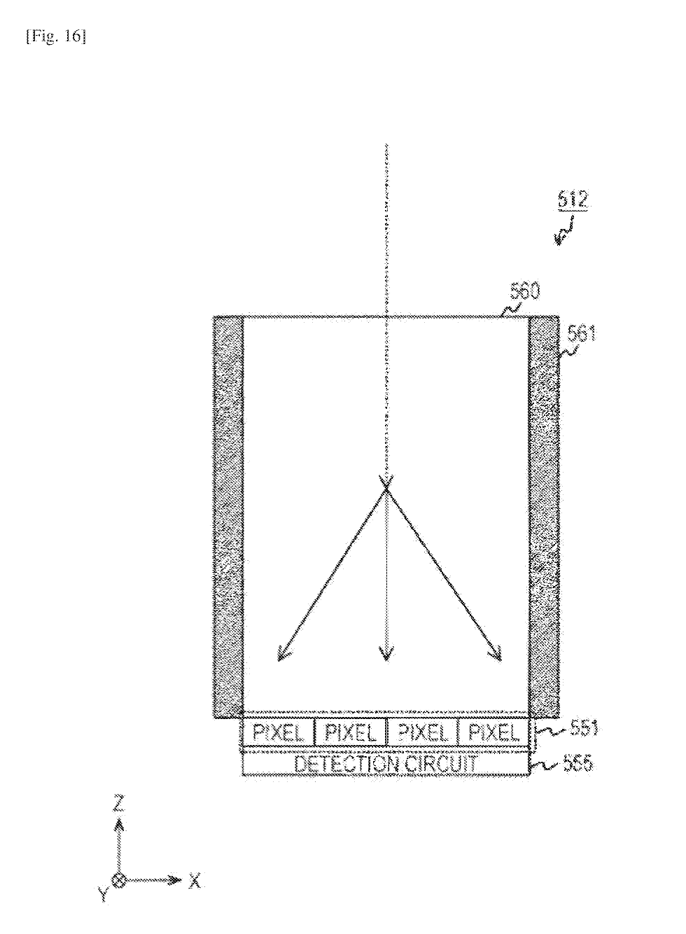

FIG. 16 is an example of a sectional view of the detection unit 512 according to the sixth embodiment of the present disclosure. In FIG. 16, dot line illustrates the radiation, and solid lines illustrate the scintillation light. As illustrated in FIG. 16, the side surfaces of the scintillation element 560 are covered by the partition walls 561. The partition wall 561 is made of a reflective material or a low refractive rate material. In addition, the light receiving unit 551 is connected to the lower surface (bonded surface) of the scintillation element 560, and the detection circuit 555 is provided on the lower layer thereof.

FIG. 17 is a schematic diagram illustrating an example of configuration of a light receiving unit 551 according to the sixth embodiment. The light receiving unit 551 includes a plurality of (for example, sixteen) pixels 552, selection transistors 553 provided for each pixel, and an electrode pad 554.

The configuration of the pixel 552 is similar to the pixel 310 in the first embodiment. The selection transistor 553 is a transistor that selects the corresponding pixel 552 and supplies the pixel signal thereof to the detection circuit 555.

In addition, the gate of the selection transistor 553 is connected to the pixel drive circuit 550, the source is connected to the corresponding pixel 552, and the drain is connected to the detection circuit 555 via the electrode pad 554. The pixel drive circuit 550 controls the selection transistor 553 and supplies the pixel signal of each of the sixteen pixels 552 to the detection circuit 555 in an order.

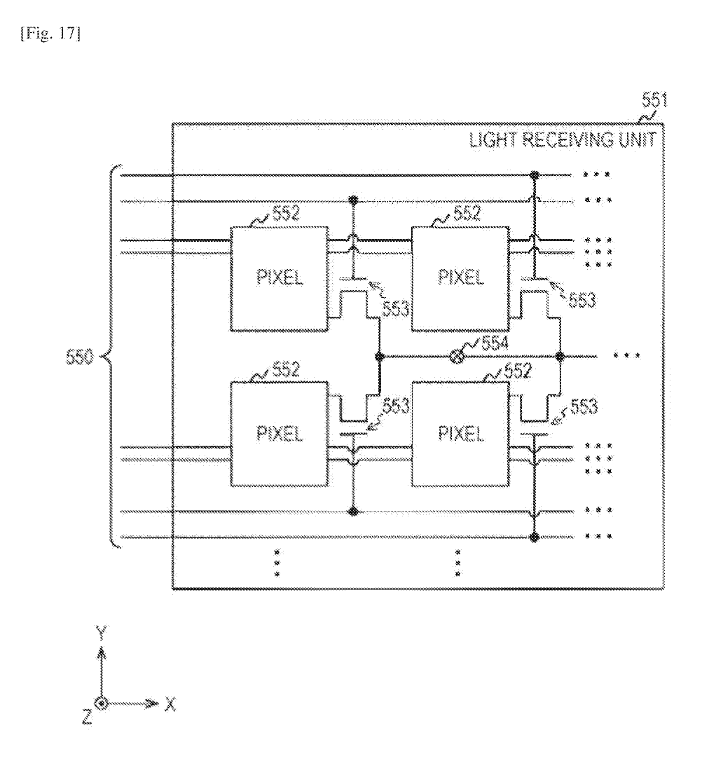

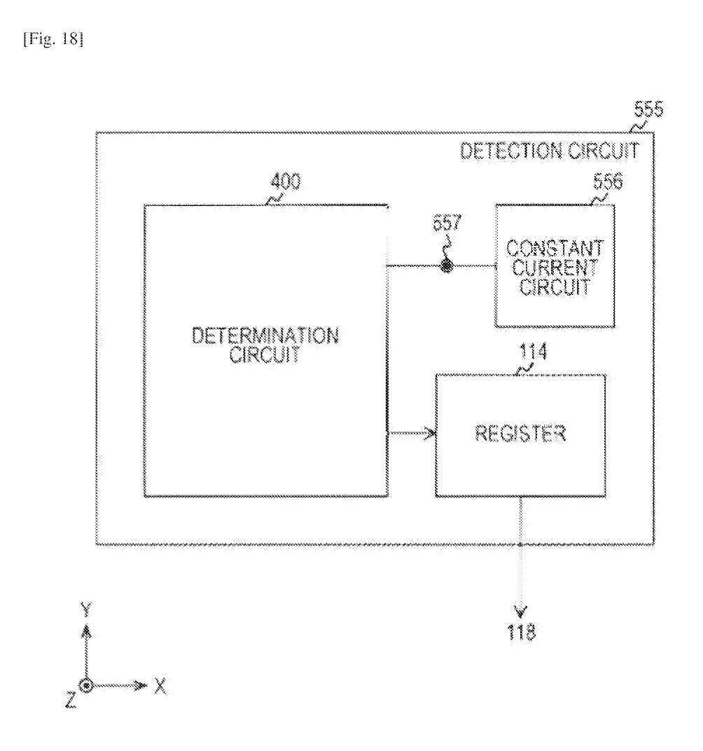

FIG. 18 is a block diagram illustrating an example of configuration of a detection circuit 555 according to the sixth embodiment. The detection circuit 555 includes the constant current circuit 556, the electrode pad 557, the determination circuit 400 and the register 114.

The constant current circuit 556 supplies a constant current. The source follower circuit is configured with the constant current circuit 556 and the amplifier transistor in the pixel 552.

The determination circuit 400 receives the pixel signal from the light receiving unit via the electrode pad 557, and generates a digital value to keep in the register 114.

In this way, according to the sixth embodiment, since the substrate on which the detection circuit 555 is provided is laminated on the substrate on which the pixel is provided, there is no need to provide the detection circuit 555 on the substrate on which the pixel is provided. Therefore, it is further possible to miniaturize the pixel.

### 7. Application Example of Present Disclosure

The imaging element on which the partitioned scintillator plates are mounted as described in the first to sixth embodiments of the present disclosure can be widely applicable to the radiation detection apparatus in the related art in which the photomultiplier tube and the avalanche photo diode, or the photo diode are provided together the scintillator.

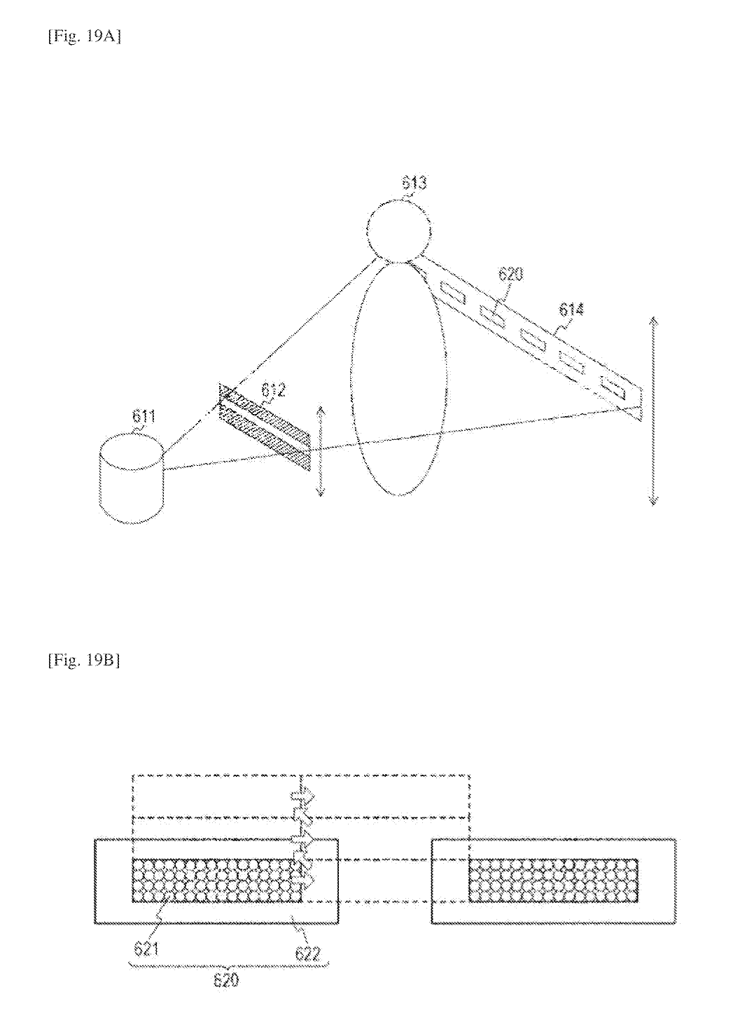

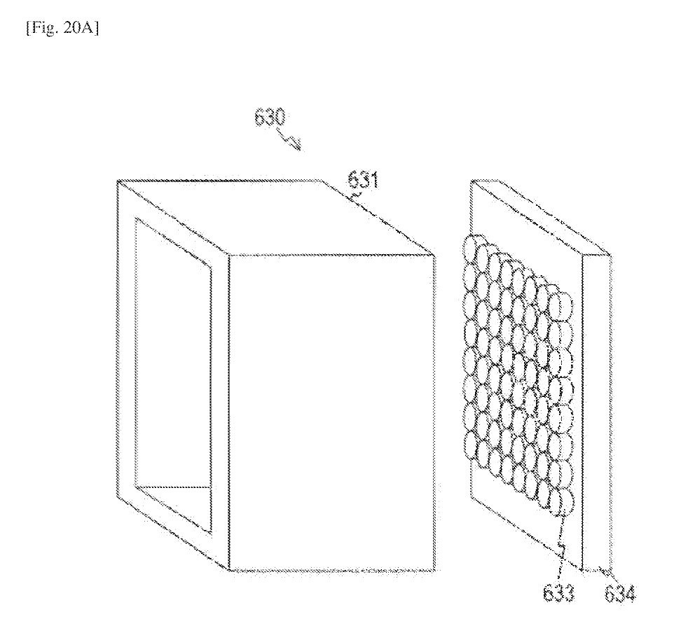

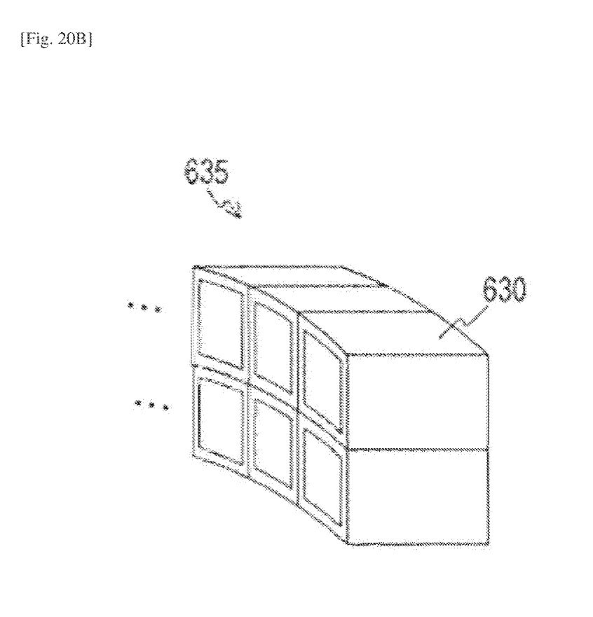

Therefore, as an example of the radiation detection apparatus, an example of X-ray scanner is illustrated in FIG. 12A and FIG. 12B, an example of X-ray CT apparatus is illustrated in FIG. 13A and FIG. 13B, and an example of a gamma camera is illustrated in FIGS. 19A and 19B and FIGS. 20A and 20B.

### Example of Application to X-ray Scanner

FIG. 19A and FIG. 19B are schematic diagrams illustrating an example of an X-ay scanner which performs the photon-count type detection (a photon-count type X-ray scanner) by applying the embodiments of the present disclosure.

In FIG. 19A, an X-ray source 611, a slit 612, a subject 613 and an X-ray detector 614 are illustrated as a conceptual diagram of the photon-count type X-ray scanner.

The X-ray radiated from the X-ray source 611 is irradiated on the subject 613 in a line shape via the slit 612. Then the X-ray passed the subject 613 (transmitted light) is incident on the X-ray detector 614. In the X-ray detector 614, a detector of the radiation (detector 620) to which the embodiments of the present disclosure is applied is provided in a predetermined interval at the position where the X-ray passed the slit 612 irradiates. When the X-ray passed the subject 613 is incident on the detector 620, the scintillation light is generated by the photons of this incident X-ray, and the detection of this generated scintillation light is performed. The detection result in the detector 620 is output as a digital data to be stored in the storage device. The stored data are used in analyzing by an analyzing device (the storage device and the analyzing device are not illustrated).

In addition, since the detector 620 in the x-ray detector 614 are disposed in a predetermined interval, by moving the X-ray detector 614 in a direction in which the slit 612 is opened (longitudinal direction), the detection at point of the slit can be finished. Then, by moving the slit and the X-ray detector 614 to the position where the detection is not performed yet, and the detection is performed at the moved position. Here, an example of the movement is described in FIG. 19B.

In this way, a two dimensional data is obtained by the detection result of the scintillation light obtained by moving the X-ray detector 614, and a two dimensional X-ray transmission image is constructed. In addition, in the detector of the radiation (detector 620) to which the embodiments of the present disclosure are applied, the size of the cross-section (light emission surface) of each scintillator of the partitioned scintillator is a limit of the space resolution.

In FIG. 19B, a diagram showing the detector 620 from the light receiving surface side is illustrated. In addition, in FIG. 19B, arrows and dot lined rectangles showing the example of movements of the detector 620 at the time of detection are illustrated. The scintillators of the detector 620 to which the embodiments of the present disclosure are applied are formed of a bundle of scintillating fibers, and the cross-section of the scintillation fiber is the light receiving surface.

In the X-ray detector 614, the detector 620 is lined in a horizontal direction (the direction in which the long slit 612 is opened (longitudinal direction)) by skipping every other line, and horizontally slides to detect without a gap at the time of detection. Then, when the detection at the position of the slit is finished after the detection without the gap, the slit 612 and the X-ray detector 614 are moved in a vertical direction to perform a scanning again.

In addition, in FIG. 19A and FIG. 19B, the description is made assuming the x-ray detector 614 in which the detector 620 is provided in a predetermined interval (skipped every other line), but not limited thereto. In a case where the detector 620 is disposed without the interval, the X-ray detector 614 may not be moved in the horizontal direction, and it is possible reduce the detection time.

For example, in the pixel array unit 510 illustrated in FIG. 9, the circuits such as the vertical drive circuit and the determination circuit are disposed in the surplus region outer side of the detection unit 512 (region 514 in FIG. 9). Then, a pad for receiving and transmitting the signal with respect to each detection unit is disposed in a direction orthogonal to the direction (vertical direction in FIG. 19B) where the long slit is opened (longitudinal direction). By continuously disposing the imaging element that includes the pixel array unit 510 in a longitudinal direction to the slit, it is possible to eliminate the region where the pixels are difficult to be arrayed in a longitudinal direction of the slit, in the X-ray detector 614. In this way, according to the X-ray detector 614 in which the imaging element that includes the pixel array units 510 is disposed continuously, the X-ray detector 614 can be moved for imaging only in a direction where the slit is moving (vertical direction), it is possible to increase the detection speed.

### Example of Application to X-Ray CT Apparatus

FIG. 20A and FIG. 20B are schematic diagrams illustrating the example of a detector of the X-ray CT apparatus to which the embodiments of the present disclosure are applied.

In addition, in FIG. 20A, the detector of the X-ray CT apparatus (detector 630) to which the embodiments of the present disclosure are applied, is illustrated in a state of the collimators being separated from the imaging element.

The detector 630 includes a collimator 631 for cutting the scattered light, which is made of lead, a partitioned scintillator plate 633 which is similar to the scintillator plate 200 in FIG. 2A and an imaging element 634.

The X-ray (primary X-ray) which is incident perpendicular to the imaging surface is incident on the scintillator plate 633 without being removed at the collimator 631. When the photons of the X-ray are incident on each scintillator of the scintillator plate 633, the scintillation light is generated from the scintillator on which the photons are incident. Then, the generated scintillation light is detected by the imaging element 634. In addition, the photons of the X-ray incident on each of the scintillators are independently detected by the imaging element 634. The detection result is output as digital data similar to the case in FIGS. 19A and 19B, accumulated in the storing device. The accumulated data is used for analyzing by the analyzing device (the storing device and the analyzing device are not illustrated).

In addition, the detectors 630 illustrated in FIG. 20A, for example, are disposed in line in a ring shape, and are used as a detection device (detection device 635 in FIG. 13B) of the CT apparatus. In addition, the detector 630 is used as one pixel per the unit of detector 630 illustrated in FIG. 20A, by the CT apparatus. In this case, the partitioned scintillators do not contribute to the improvement of the space resolution. However, by independently detecting the scintillation light generated by the photons of the X-ray incident on each of the scintillators, it is possible to correctly detect the number of photons of the X-ray incident on the detector 630. By correctly detecting the number of photons of the X-ray incident on the detector 630, the number of photons that are difficult to be identified is decreased, and the dynamic range can be improved.

### Example of Application to Gamma Camera

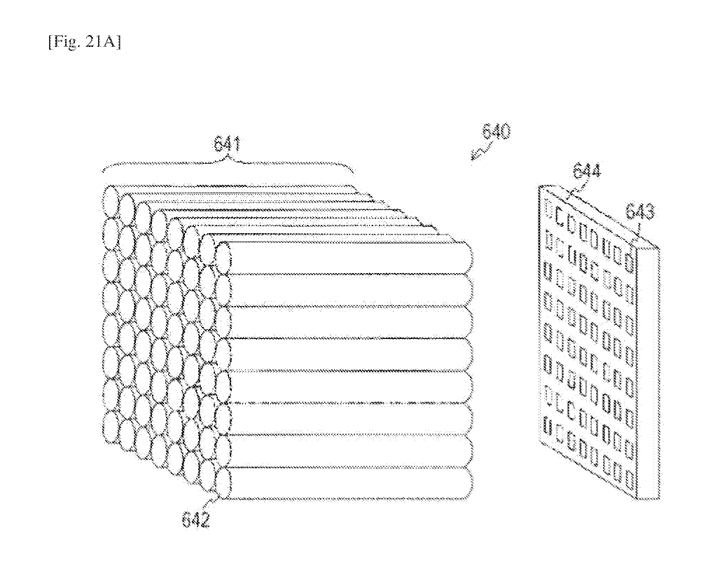

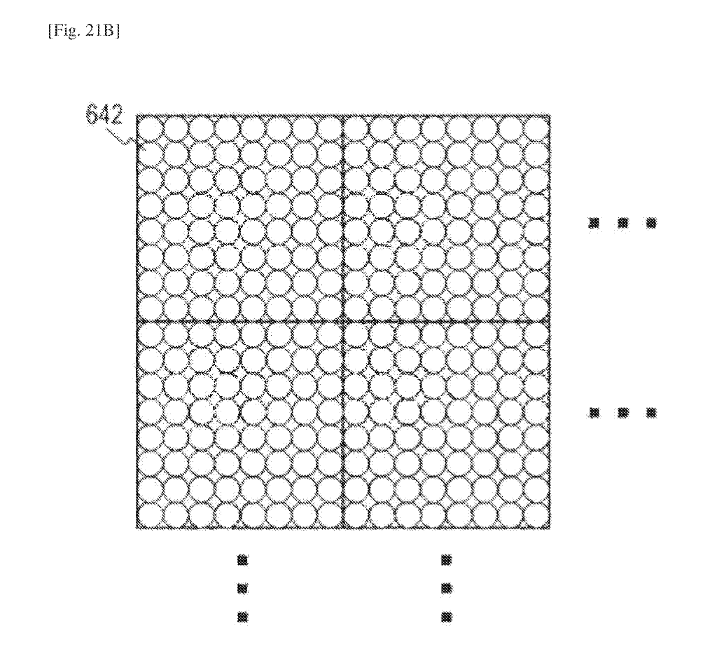

FIG. 21A and FIG. 21B are schematic diagrams illustrating an example of a detector of a gamma camera to which the embodiments of the present disclosure are applied.

In addition, in FIG. 21A, the detector 640 of the gamma camera to which the embodiments of the present disclosure are applied, is illustrated in a state of the scintillator plate 641 being separated from the imaging element.

Since the gamma ray has high energy, the ray penetrates the thin scintillator. Therefore, when manufacturing the scintillator plate 641, the scintillator plate 641 is manufactured by bundling the scintillator 642, by making the length of each scintillator 642 (a distance between the incident surface of the radiation and the surface bonded to the imaging element) long. For example, in the scintillator plate 641, the cut surface (the surface bonded to the imaging element) of the scintillator 642 has a diameter of one millimeter, the scintillators 642 of approximately one centimeter, of which the approximate number matches the size of the imaging element (8 rows*8 columns in FIG. 21A) are bundled. That is, in the example in FIG. 21A, an example of the detector is illustrated, in which the 8 millimeter angle scintillator plate 641 where the scintillators 642 having one millimeter diameter ate bundled to the extent of 8 rows*8 columns, is bonded to the imaging element 644.

In the pixel array unit of the imaging element 644, the detection units are disposed in approximately 8 rows*8 columns in accordance with the pitch (1 mm) and the arrayal of the scintillator 642, as similar to the pixel array unit 510 illustrated in FIG. 9. For example, when the pixel of 5 micrometers angle is arrayed in the detection unit in approximately 100 rows*100 columns, the imaging element 644 can detect the light of the gradation 10,001 (no counting included) by photon counting. In addition, by disposing the vertical drive circuit and the determination circuit at the outside of the detection unit as described in FIG. 9, FIG. 19A and FIG. 19B, the detection unit of 8 rows*8 columns can be driven in parallel, the high speed imaging can be performed. In addition, in the detector 640, the size of the cross-section of the scintillator 642 is a unit of the resolution, the gamma ray detection and the determination of the energy are performed per each detection unit.

By disposing a plurality of detectors 640 in an array without the gap as illustrated in FIG. 21A, a wide area of imaging area can be realized, it is possible to manufacture the gamma camera having the wide imaging area as illustrated in FIG. 21B.

In this way, according to the embodiments of the present disclosure, it is possible to improve the accuracy in photo counting of the radiation. In particular, it is possible to prepare an extremely high performance in radiation counting. In addition, since it can be mass-produced at a low price for mounting the partitioned scintillators on the CMOS image sensor or the CCD image sensor, a number of light detectors can be provided in the electronic apparatus on which only a small number of light detectors are provided due to the high price of the photomultiplier tube, and it is possible to improve the detection speed.

In addition, it is advantageous not only in the electronic apparatus that includes large type detectors but also the similar advantages in the electronic apparatus using small type detectors can be obtained. For example, if the present disclosure is applied to a scintillation dosimeter of radiation, it is possible to realize a small and light pocket dosimeter having a high counting performance using a cheap semiconductor imaging element.

In addition, the above embodiments are described by way of exemplary embodiments to realize the present disclosure, the description in the embodiments and the specific disclosures in the claims appended hereto have corresponding relationship respectively. Similarly, the specific disclosures in the claims appended hereto and the descriptions in the embodiments of the present disclosure with the similar names thereto have correspondence relationship respectively. However, the present disclosure is not limited to the embodiments, a variety of modifications to the embodiments can be implemented and realized without departing from the scope of the present disclosure.

In addition, the procedures in the above-described embodiments may be regarded as methods having such a series of procedures, or may be regarded as a program or a recording medium for storing the program for causing a computer to execute the series of procedures. As the examples of such recording medium, a hard disc, a CD (Compact Disk), an MD (Minidisc), a DVD (Digital Versatile Disk), a memory card, a Blu-ray Disc (registered trade mark) can be used.

The effects described here are not necessarily limited thereto, and they may be the effects of any descriptions described in this disclosure.

In addition, the present disclosure may be configured as described below.
1. A radiation counting device includes: a plurality of photo diodes to which a bias voltage lower than a breakdown voltage is applied, a charge accumulation unit that accumulates charges which are photo-electric converted by the photo diodes, and generates an electric signal having a signal voltage corresponding to the amount of accumulated charges; a plurality of scintillators that generates scintillation light when a radiation is incident, and irradiates the generated scintillation light to the plurality of photo diodes; and a data processing unit that measures the amount of the scintillation light for each scintillator based on the electric signal.
2. The radiation counting device according to the above-described 1, further includes a conversion circuit that converts the electric signal to a signal indicating the presence or absence of a photon incident on the photo diodes for each photo diode, and the data processing unit therein measures the amount of light for each scintillator based on the converted electric signal.
3. The radiation counting device according to above-described 1, further includes a conversion circuit that converts the electric signal to a signal indicating the presence or absence of a photon incident on the photo diodes for each photo diode, and the data processing unit therein measures the amount of light for each scintillator based on the converted electric signal.
4. The radiation counting device according to any of above-described 1 to 3, further includes a conversion circuit that converts the electric signal to a signal indicating the number of photons, and the charge accumulation unit and the plurality of photo diodes therein are provided on one of the two substrates which are laminated, and the conversion circuit therein is provided on the other substrate of the two substrates.
5. In the radiation counting device according to any of above-described 1 to 4, the data processing unit, acquires the electric signal generated by a plurality of pixels which include the photo diodes and the charge accumulation unit, and detects the pixels of which signal voltage at the time when the radiation is incident is higher than the predetermined value as defective pixels, and corrects the amount of light based on the number of defective pixels.
6. In the radiation counting device according any of above-described 1 to 5, the plurality of scintillators irradiate the scintillation light on the mutually different region of the vertical surface which is vertical to the incident direction of the radiation, and the plurality of photo diodes are provided on each of the regions.
7. In the radiation counting device according to above-described 6, the photo diodes are provided only on the region in the vertical surface.
8. The radiation counting device according to any of above-described 1 to 5, the plurality of scintillators irradiate the scintillation light on the mutually different region of the vertical surface which is vertical to the incident direction of the radiation, and one photo diode is provided on each of the regions.
9. In the radiation counting device according to any of above-described 1 to 8, the charge accumulation unit is provided for each of the plurality of pixels which include the photo diodes respectively, and accumulates the charges by adding the amount of charges generated by the plurality of corresponding pixels.
10. The radiation counting, device according to any of above-described 1 to 8, further includes an adding unit that is provided for each of the plurality of pixels which include the photo diodes and the charge accumulation unit respectively, and adds the signal voltage generated by the plurality of corresponding pixels to each other, and the data processing unit therein measures the amount of the light based on the electric signal having the added signal voltage.

The present disclosure may also be configured as described below,
(1) An imaging device comprising:
   a scintillator plate configured to convert incident radiation into scintillation light; and
   an imaging element configured to convert the scintillation light to an electric signal, wherein
   the scintillator plate includes a first scintillator partitioned from a second scintillator by a divider in a direction perpendicular to a propagation direction of the incident radiation, the divider preventing first scintillation light generated in the first scintillator from diffusing into the second scintillator and second scintillation light generated in the first scintillator from diffusing into the first scintillator.
(2) The imaging device according to (1) above or (3) to (16) below, further comprising a data processing unit configured to analyze the incident radiation based on the electric signal.
(3) The imaging device according to (1) or (2) above or (4) to (6) below, wherein the scintillator plate is disposed adjacent to the imaging element.
(4) The imaging device according to (1) to (3) above or (5) to (16) below, wherein the imaging element includes a plurality of pixels arrayed in a matrix form, the plurality of pixels including pixels of a first detection unit corresponding to the first scintillator and pixels of a second detection unit corresponding to the second scintillator.
(5) The imaging device according to (1) to (4) above or (6) to (16) below, wherein the imaging element includes a complementary metal oxide semiconductor (CMOS) sensor.
(6) The imaging device according to (1) to (5) above or (7) to (16) below, wherein the first and the second scintillators are formed from a glass material including a scintillation material.
(7) The imaging device according to (1) to (6) above or (8) to (16) below, wherein the first and the second scintillators are formed from a plastic material including a scintillation material.
(8) The imaging device according to (1) to (7) above or (9) to (16) below, wherein the divider includes a reflecting agent.
(9) The imaging device according to (1) to (8) above or (10) to (16) below, wherein the divider includes an adhesive that bonds the first scintillator to the second scintillator.
(10) The imaging device according to (1) to (9) above or (11) to (16) below, wherein the divider includes a material having a refractive index lower than a refractive index of the first or second scintillator.
(11) The imaging device according to (1) to (10) above or (12) to (16) below, wherein the scintillator plates include a plurality of scintillators, each of the plurality of scintillators being formed from a scintillating fiber, each the plurality of scintillators being bound together with an adhesive.
(12) The imaging device according to (1) to (11) above or (13) to (16) below, wherein the first scintillator includes a clad portion formed around a core portion, the clad portion being formed from a material having a lower refractive index than the core portion.
(13) The imaging device according to (1) to (12) above or (14) to (16) below, further comprising a first collimator formed on a surface of scintillator plate opposite from the imaging element, the first collimator being configured to collimate a first portion of the incident radiation onto the first scintillator.
(14) The imaging device according, to (1) to 3) above or (15) or (16) below, further comprising a second collimator formed on the surface of scintillator plate opposite from the imaging element, the second collimator being configured to collimate a second portion of the incident radiation onto the second scintillator.
(15) An electronic apparatus comprising the imaging device, according to (1) to (14) above or (16) below.
(16) The electronic apparatus according to (1) to (15) above, wherein the imaging device is configured to detect gamma rays or X-rays.
(17) An imaging method comprising:
   generating first scintillation light upon receiving first incident radiation, the first incident radiation being incident on a first cross-sectional area;
   generating second scintillation light upon receiving second incident radiation, the second incident radiation being incident on a second cross-sectional area, the second cross-sectional area being different than the first cross-sectional area;
   preventing diffusion of the first scintillation light into the second cross-sectional area, the second cross-sectional area extending in a direction parallel to a propagation direction of the first and second incident radiation;
   preventing diffusion of the second scintillation light into the first cross-sectional area, the first cross-sectional area extending in the direction parallel to the propagation direction of the first and second incident radiation;
   converting the first scintillation light to a first electric signal; and
   converting the second scintillation light to a second electric signal.
(18) The imaging method according to (17) above or (20) to (28) below, further comprising
   analyzing the first and the second incident radiation based on the first and the second electric signals.
(19) The imaging method according to (17) or (18) above or (20) to (28) below, wherein the first scintillation light and the second scintillation light are generated in a scintillator plate disposed adjacent to an imaging element.
(20) The imaging method according to (17) to (19) above or (21) to (28) below, wherein the imaging element includes a plurality of pixels arrayed in a matrix form, the plurality of pixels including pixels of a first detection unit corresponding to a first scintillator and pixels of a second detection unit corresponding to a second scintillator, wherein the first scintillator is partitioned from the second scintillator by a divider in a direction perpendicular to a propagation direction of the first incident radiation and the second incident radiation.
(21) The imaging method according to (17) to (20) above or (22) to (28) below, wherein the imaging element includes a complementary metal oxide semiconductor (CMOS) sensor.
(22) The imaging method according to (17) to (20 above or (23) to (28) below, wherein the first and the second scintillators are formed from a glass material including a scintillation material.
(23) The imaging method according to (17) to (22) above or (24) to (28) below, wherein the first and the second scintillators are formed from a plastic material including a scintillation material.
(24) The imaging method according to (17) to (23) above or (25) to (28) below, wherein the divider includes a reflecting agent.
(25) The imaging method according to (17) to (24) above or (26) to (28) below, wherein the divider includes an adhesive that bonds the first scintillator to the second scintillator.
(26) The imaging method according to (17) to (25) above or (27) or (28) below, wherein the divider includes a material having a refractive index lower than a refractive index of the first or second scintillator.
(27) The imaging method according to (17) to (26) above (28) below, wherein the first scintillator includes a clad portion formed around a core portion, the clad portion being formed from a material having a lower refractive index than the core portion.
(28) The imaging method according to (17) to (27) above, wherein the first incident radiation and the second incident radiation are gamma rays or X-rays.
(29) An imaging device comprising:
   means for generating first scintillation light upon receiving first incident radiation, the first incident radiation being incident on a first cross-sectional area;
   means for generating second scintillation light upon receiving second incident radiation, the second incident radiation being incident on a second cross-sectional area, the second cross-sectional area being different than the first cross-sectional area;
   means for preventing diffusion of the first scintillation light into the second cross-sectional area, the second cross-sectional area extending in a direction parallel to a propagation direction of the first and second incident radiation;
   means for preventing diffusion of the second scintillation light into the first cross-sectional area, the first cross-sectional area extending in the direction parallel to the propagation direction of the first and second incident radiation;
   means for converting the first scintillation light to a first electric signal; and
   means for converting the second scintillation light to a second electric signal.

The present disclosure contains subject matter related to that disclosed in Japanese Priority Patent Applications JP 2012-277559 and JP 2013-217060 filed in the Japan Patent Office on Dec. 20, 2012, and Oct. 18, 2013, respectively the entire contents of which are hereby incorporated by reference.

### REFERENCE SIGNS LIST

10 radiation detection device
100 detector
101, 191 collimator
110 imaging element
112 first vertical drive circuit
114 register
115 second vertical drive circuit
118 output circuit
120 data processing unit
190 scintillator
193 photomultiplier tube
194 conversion unit
195 data processing unit
200 scintillator plate
300, 510, 520 pixel army unit
310, 513, 522, 534, 542, 552 pixel
311 photo diode
312 transfer transistor
313 reset transistor
314, 545 amplifier transistor
322, 544 FD
400 determination circuit
541 sub-unit
543 intermediate node
550 pixel drive circuit
551 light receiving unit
553 selection transistor
554, 557 electrode pad
555 detection circuit
556 constant current circuit
560 scintillation element
561 partition wall

What is claimed is:

1. An imaging device comprising:
a scintillator plate configured to convert incident radiation into scintillation light; and
an imaging element configured to convert the scintillation light to an electric signal, wherein
the scintillator plate includes a first scintillator partitioned from a second scintillator by a divider in a direction perpendicular to a propagation direction of the incident radiation, the divider preventing first scintillation light generated in the first scintillator from diffusing into the second scintillator and second scintillation light generated in the first scintillator from diffusing into the first scintillator.

2. The imaging device according to claim 1, further comprising a data processing unit configured to analyze the incident radiation based on the electric signal.

3. The imaging device according to claim 1, wherein the scintillator plate is disposed adjacent to the imaging element.

4. The imaging device according to claim 1, wherein the imaging element includes a plurality of pixels arrayed in a matrix form, the plurality of pixels including pixels of a first detection unit corresponding to the first scintillator and pixels of a second detection unit corresponding to the second scintillator.

5. The imaging device according to claim 4, wherein the imaging element includes a complementary metal oxide semiconductor (CMOS) sensor.

6. The imaging device according to claim 1, wherein the first and the second scintillators are formed from a glass material including a scintillation material.

7. The imaging device according to claim 1, wherein the first and the second scintillators are formed from a plastic material including a scintillation material.

8. The imaging device according to claim 1, wherein the divider includes a reflecting agent.

9. The imaging device according to claim 1, wherein the divider includes an adhesive that bonds the first scintillator to the second scintillator.

10. The imaging device according to claim 1, wherein the divider includes a material having a refractive index lower than a refractive index of the first or second scintillator.

11. The imaging device according to claim 1, wherein the scintillator plates include a plurality of scintillators, each of the plurality of scintillators being formed from a scintillating fiber, each the plurality of scintillators being bound together with an adhesive.

12. The imaging device according to claim 1, wherein the first scintillator includes a clad portion formed around a core portion, the clad portion being formed from a material having a lower refractive index than the core portion.

13. The imaging device according to claim 1, further comprising a first collimator formed on a surface of scintillator plate opposite from the imaging element, the first collimator being configured to collimate a first portion of the incident radiation onto the first scintillator.

14. The imaging device according to claim 13, further comprising a second collimator formed on the surface of scintillator plate opposite from the imaging element, the second collimator being configured to collimate a second portion of the incident radiation onto the second scintillator.

15. An electronic apparatus comprising the imaging device, according to claim 1.

16. The electronic apparatus according to claim 15, wherein the imaging device is configured to detect gamma rays or X-rays.

17. An imaging method comprising:
generating first scintillation light upon receiving first incident radiation, the first incident radiation being incident on a first cross-sectional area;
generating second scintillation light upon receiving second incident radiation, the second incident radiation being incident on a second cross-sectional area, the second cross-sectional area being different than the first cross-sectional area;
preventing diffusion of the first scintillation light into the second cross-sectional area, the second cross-sectional area extending in a direction parallel to a propagation direction of the first and second incident radiation;
preventing diffusion of the second scintillation light into the first cross-sectional area, the first cross-sectional area extending in the direction parallel to the propagation direction of the first and second incident radiation;
converting the first scintillation light to a first electric signal; and
converting the second scintillation light to a second electric signal.

18. The imaging method according to claim 17, further comprising
analyzing the first and the second incident radiation based on the first and the second electric signals.

19. The imaging method according to claim 17, wherein the first scintillation light and the second scintillation light are generated in a scintillator plate disposed adjacent to an imaging element.

20. The imaging method according to claim 17, wherein the imaging element includes a plurality of pixels arrayed in a matrix form, the plurality of pixels including pixels of a first detection unit corresponding to a first scintillator and pixels of a second detection unit corresponding to a second scintillator,
wherein the first scintillator is partitioned from the second scintillator by a divider in a direction perpendicular to a propagation direction of the first incident radiation and the second incident radiation.

21. The imaging method according to claim 20, wherein the imaging element includes a complementary metal oxide semiconductor (CMOS) sensor.

22. The imaging method according to claim 20, wherein the first and the second scintillators are formed from a glass material including a scintillation material.

23. The imaging method according to claim 20, wherein the first and the second scintillators are formed from a plastic material including a scintillation material.

24. The imaging method according to claim 20, wherein the divider includes a reflecting agent.

25. The imaging method according to claim 20, wherein the divider includes an adhesive that bonds the first scintillator to the second scintillator.

26. The imaging method according to claim 20, wherein the divider includes a material having a refractive index lower than a refractive index of the first or second scintillator.

27. The imaging method according to claim 20, wherein the first scintillator includes a clad portion formed around a core portion, the clad portion being formed from a material having a lower refractive index than the core portion.

28. The imaging method according to claim 17, wherein the first incident radiation and the second incident radiation are gamma rays or X-rays.

29. An imaging device comprising:
means for generating first scintillation light upon receiving first incident radiation, the first incident radiation being incident on a first cross-sectional area;
means for generating second scintillation light upon receiving second incident radiation, the second incident radiation being incident on a second cross-sectional area, the second cross-sectional area being different than the first cross-sectional area;
means for preventing diffusion of the first scintillation light into the second cross-sectional area, the second cross-sectional area extending in a direction parallel to a propagation direction of the first and second incident radiation;
means for preventing diffusion of the second scintillation light into the first cross-sectional area, the first cross-sectional area extending in the direction parallel to the propagation direction of the first and second incident radiation;
means for converting the first scintillation light to a first electric signal; and
means for concerting the second scintillation light to a second electric signal.
